(19) United States
(12) Patent Application Publication
(10) Pub. No.: US 2007/0073562 A1
(43) Pub. Date: Mar. 29, 2007

(54) System, method, and computer program product for providing travel information using information obtained from other travelers

(75) Inventors: Tony Brice, Colleyville, TX (US); Daniel C. Delph, Euless, TX (US); George Heil, Keller, TX (US); Ladislav Lettovsky, Eagle-Vail, CO (US); Joseph Robert Offutt, Grapevine, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: SABRE INC.

(21) Appl. No.: 11/237,528

(22) Filed: Sep. 28, 2005

(51) Int. Cl. G06Q 10/00

(52) U.S. Cl. 705/5

(57) ABSTRACT

A system, method, and computer program product provide and display travel information in response to a request from a user. The travel information may be obtained from many different sources, such as trip journal websites, and may comprise complete or partial travel itineraries, as well as textual, audio, or video descriptions, ratings, photographs, and other useful information related to geographic destinations, components, points of interest, transportation methods and providers, and the like. The user may select bookable and non-bookable components, or a complete or partial itinerary, that the user desires to incorporate into an itinerary. The price and availability of each selected component may be determined and displayed. An optimized schedule may be suggested for the selected components. The bookable items may be booked by transmitting information to a global distribution system. The user itinerary may then be stored for use as travel information for a future user request.

### FIELD OF THE INVENTION

Embodiments of the invention relate generally to travel planning systems, and more particularly, to systems, methods, and computer program products capable of providing travel planning information using information obtained from other travelers.

### BACKGROUND OF THE INVENTION

Before the advent of the Internet and the World Wide Web, travel planning and booking travel accommodations was a difficult and time-consuming task, generally requiring the assistance of a travel agent. The Internet has made travel planning significantly easier. Travel planning websites have enabled travelers to research, plan, and book travel without the assistance of a travel agent. In particular, booking individual travel accommodations, such as an airline flight from city A to city B or a hotel room in city B, is readily performed using a travel planning website. Travel accommodations such as airline tickets, hotel reservations, rental car reservations, and the like may be termed bookable travel components. Booking individual travel accommodations enables a traveler to secure exactly the accommodations that fit the traveler's needs. However, this may be somewhat time-consuming because each individual travel accommodation must be separately searched, confirmed to be available, and booked.

Booking travel packages, such as might include an airline flight, a hotel room, and rental car all purchased together, is also readily performed using a travel planning website. Booking such travel packages is typically faster and easier than booking individual travel accommodations, as the traveler can search, confirm availability, and book the package together.

Even with the ability to book travel packages, however, there may be some drawbacks to using travel planning websites. The travel packages offered by travel planning websites may be limited, such that the traveler may have difficulty finding a suitable travel package. Additionally, the travel packages offered by travel planning websites may not include information regarding attractions, activities, and points of interest for which the travel planning website does not sell reservations. Such attractions, activities, and points of interest may be termed non-bookable travel components. These components may be non-bookable because there is no admission charge to participate or visit, because admission tickets may only be purchased at the entry point of the attraction, or because the travel planning website does not have an agreement with the owner/operator of the attraction enabling the website to sell reservations. Examples of such non-bookable components may include beaches, parks, historical sites, walking tours, and hiking trails.

There are many other sources of information available on the Internet for such non-bookable travel components. The owner/operator of the attraction may have a website providing information such as hours of operation and entry fee, if any. However, a traveler may need to do a large amount of research just to identify potential non-bookable travel components, and then spend a great deal of time searching for and reviewing the related websites. Even after locating a website, the information available on a website provided by the owner/operator would likely not include unbiased opinions regarding the quality of the activity. Even if the traveler identifies desired non-bookable travel components, the traveler would then have to manually compile information, such as entry fee and hours of operation, to create a travel itinerary and then return to a travel planning website to book the bookable components, such as the airline flight and hotel room.

Another source for travel related information on the Internet is online trip journals. Online trip journals are websites that enable travelers to plan, discuss, and share travel information. The trip journal websites may be created by an individual traveler for only that traveler's personal travel information, or may be created by a third party to enable many different travelers to create and share trip journals. Trip journals may be relatively freeform such that the traveler enters travel information in any desired format, or may be relatively structured such that the traveler is provided with defined spaces and formats to enter itineraries, descriptions, reviews,-ratings, suggestions, tips, photographs, and the like. An itinerary may be-a record of a past or future trip, typically providing the day-by-day details. An itinerary may be simply a list of the geographic location of the traveler each day of the trip. Alternatively, an itinerary may be a detailed list of all activities, points of interest, lodging, and transportation for a trip. Trip journal websites, particularly those that include trip journals from many different travelers, may provide a great deal of centralized information on a large number of travel components, both bookable and non-bookable. However, after identifying desirable components, the traveler must still manually compile the information to create a travel itinerary and then return to a travel planning website to book the bookable components. Additionally, some of the information contained in such trip journals, such as entry fees and hours of operation, may be inaccurate, either because the information was entered into the trip journal incorrectly or because the information is out of date.

As such, there is a need for a system, method, and computer program product capable of providing travel planning information using information obtained from many different sources and enabling a traveler or a traveler's agent to quickly and easily create and book a travel itinerary using the provided travel information.

### BRIEF SUMMARY OF THE INVENTION

A system, method, and computer program product are therefore provided that access and display travel information in response to a request from a user. The travel information may be obtained from many different sources, such as trip journal websites, and may comprise complete or partial travel itineraries, as well as textual, audio, or video descriptions, reviews, comments, ratings, suggestions, tips, photographs, website links, and other useful information related to geographic destinations, activities, points of interest, transportation methods and providers, and the like. In response to a user request, travel information corresponding to and satisfying the user request is accessed and displayed for the user. After reviewing the travel information, the user may select bookable components (such as an airline flight, a hotel, and a rental car) and non-bookable components (such as a museum, a walking tour, and a city park) that the user desires to incorporate into an itinerary. Additionally or alternatively, the user may select an entire itinerary or a portion of an itinerary from the travel information, or the user may select all of the travel components corresponding to one or more individual days within an itinerary. The user will typically select an itinerary or a component by dragging and dropping a virtual object corresponding to the desired itinerary or component into a virtual shopping cart, although the user may make a selection using any suitable selection mechanism. The user will then typically schedule each selected travel component into a desired day and/or time, such that the selected and scheduled components are used to create the user itinerary. After the user itinerary is created, the price and availability of each component in the user itinerary may be determined and displayed. The system, method, and computer program product of the invention may suggest an optimized schedule for the selected components, based on a number of factors, such as availability, price, and logistics of travel, however the user may reschedule one or more components if desired. When the user is satisfied with the user itinerary, the system, method, and computer program product of the invention may book the bookable components by transmitting information to a global distribution system (GDS) or a computerized reservation system (CRS). After the user itinerary is completed, the system, method, and computer program product of the invention may store the user itinerary for use as travel information for a future user request.

In this regard, a system for providing travel information using information obtained from other travelers comprises a client device and a server. The client device is capable of receiving a request from a user. The server is capable of accessing travel information in response to the request from the user. The travel information may comprise at least a portion of a predefined travel itinerary. The predefined travel itinerary may correspond to a previously planned itinerary, or some portion thereof, of a traveler different from the user. The predefined travel itinerary may comprise a plurality of bookable and non-bookable travel components. The server may be further capable of transmitting the travel information to be displayed at the client device. Thereafter, the server may be further capable of creating a user itinerary comprising at least one travel component in response to a selection by the user of at least a portion of the displayed travel information.

In one embodiment, the travel information further comprises previously experienced travel component information, the previously experienced travel component information corresponding to a previously experienced travel component of a traveler different from the user. The previously experienced travel component may be designated as a bookable or non-bookable travel component. The previously experienced travel component information may comprise a name of the previously experienced travel component and at least one of a location of the previously experienced travel component, a description of the previously experienced travel component, a review of the previously experienced travel component, a suggestion or tip corresponding to the previously experienced travel component, a website link corresponding to the previously experienced travel component, a product or service menu corresponding to the previously experienced travel component, a rating of the previously experienced travel component, and a photograph of the previously experienced travel component.

The client device may be capable of displaying the travel information by displaying an icon or any suitable visual indicator on a map, with the location of the icon on the map corresponding to a geographic location of at least one of a bookable travel component, a non-bookable travel component, and a previously experienced travel component. The icon may have a visual aspect corresponding to a category of the travel component.

In one embodiment, the request from the user comprises at least one of a key word query, a selection from a drop down list, a selection of a geographic area on a map, and a drag-and-drop selection and placement on a map of an icon corresponding to a travel component category. The selection by the user may comprise a drag-and-drop selection and placement of at least one of the predefined travel itinerary, a portion of the predefined travel itinerary, all travel components corresponding to a day of travel in the predefined travel itinerary, a bookable travel component, a non-bookable travel component, an icon, a previously experienced travel component name, a previously experienced travel component photograph, a website link, and a product or service menu.

The server may be further capable of determining a price and availability of each travel component in the user itinerary and also capable of determining a total price of the user itinerary. Additionally, the server may be further capable of rescheduling at least one travel component in the user itinerary, such that the user itinerary is optimized based on at least one of number of days of travel, a number of travel components selected, a length of time required for each travel component, a rating of each selected travel component, an availability of each selected travel component, a total price of the user itinerary, a total price of the user itinerary compared to a user budget, a travel time required between each travel component, a geographic location of each travel component, a desired amount of free time, and a predefined user preference. Further, the server may be capable of moving a selected travel component from one day of travel to a different day of travel or from one period of time to a different period of time in response to a drag-and-drop selection and placement by the user.

In one embodiment, the server is further capable of sending the user itinerary to a global distribution system or a computerized reservation system such that the global distribution system or the computerized reservation system creates a reservation record. The reservation record may comprise a reservation for each bookable travel component and a remark for each non-bookable travel component.

The server may be further capable of storing the user itinerary, such that the stored user itinerary is a predefined travel itinerary that the server may use to access travel information in response to a subsequent user request. The server may be further capable of receiving user feedback corresponding to at least one travel component in the user itinerary, the user feedback comprising at least one of a description of the travel component, a review of the travel component, a suggestion or tip corresponding to the travel component, a rating of the travel component, a website corresponding to the travel component, a product or service menu corresponding to the travel component, and a photograph of the travel component. The server may be further capable of storing the received user feedback, such that the stored user feedback is previously experienced travel component information that the server may use to access travel information in response to a subsequent user request.

In addition to the system for providing travel planning information using information obtained from other travelers as described above, other aspects of the invention are directed to corresponding methods and computer program products for providing travel planning information using information obtained from or related to other travelers.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a system for providing travel information, according to one embodiment of the invention;

FIG. 2 is a flowchart of the operation of providing travel information, according to one embodiment of the invention;

FIG. 3 is a screen shot of a request entry screen for entering a user request, according to one embodiment of the invention;

FIG. 4 is a screen shot of a request entry screen for entering a user request, according to one embodiment of the invention;

FIG. 5 is a screen shot of a request entry screen for further restricting a user request, according to one embodiment of the invention;

FIGS. 6-8 are screen shots of results from a user request, according to one embodiment of the invention;

FIGS. 9-12 are screen shots of results from a user request and from a user selection of travel components, according to one embodiment of the invention;

FIG. 13-15 are screen shots of results from a user request, according to one embodiment of the invention;

FIGS. 16-21 are screen shots illustrating the creation of a user itinerary, according to one embodiment of the invention; and

FIG. 22 is a screen shot of a request entry screen for entering a user request, according to one embodiment of the invention.

### DETAILED DESCRIPTION OF THE INVENTION

Embodiments of the invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

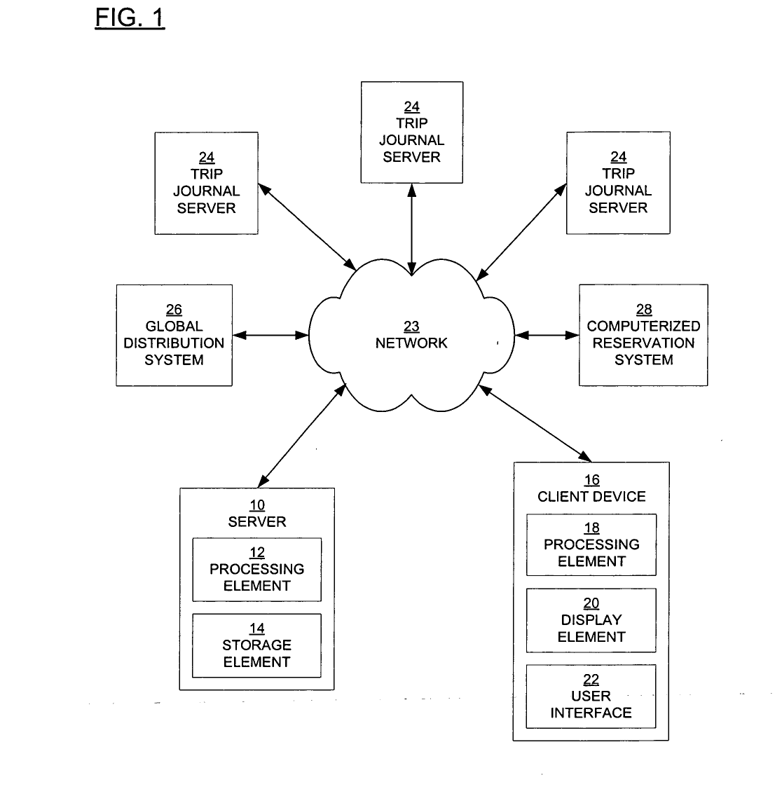

FIG. 1 is a schematic block diagram of a system for providing travel information, according to one embodiment of the invention. FIG. 1 illustrates a system using a client/server configuration. The system of FIG. 1 comprises a server 10 and a client device 16, in communication over a network 23, such as the Internet. The server 10 comprises a processing element 12 and a storage element 14. The client device comprises a processing element 18, a display element 20, and a user interface 22. The client device 16 would typically be a personal computer, but may be any suitable device. The display element 20 may be, for example, a CRT or LCD, and the user interface may be, for example, a keyboard and/or a pointing device such as a mouse.

Server 10 may communicate over network 23 with many different sources of travel information, such as servers 24 which host online trip journals, to obtain travel information created by many different travelers. Although not illustrated, server 10 may communicate with other available sources of travel information, such as weblogs, travel information websites, and personal websites. Travel information may be also obtained from any device capable of providing travel information and communicating over a wired or wireless network. Travel information may be obtained using peer-to-peer data sharing techniques. The obtained travel information may include complete travel itineraries, either from completed trips or from planned but not yet completed trips. The obtained travel information may also include information about discrete travel components separate from a complete travel itinerary. The processing element 12 of the server will typically parse the obtained travel information to identify bookable and non-bookable components within the information. The processing element 12 will also typically geo-code the information to indicate a correspondence between the information and one or more defined geographic areas. The processing element 12 will also typically categorize the information. The information may be categorized through the use of tagging, keywords, taxonomies, ontologies, or any method typically associated with the categorization of information. The information may be categorized in many different ways. For example, a travel component may be categorized as transportation, lodging, or attraction. Additionally, sub-categories may be used. For example, within the transportation category, some sub-categories may include airline, bus, and train. Information may also be categorized by the type of trip or the experience associated with the itinerary travel component. For example, an itinerary or travel component may be related to an outdoor adventure, fun in the sun, wine tasting, or gambling trip. Information may also be categorized by the typical traveler to whom the itinerary or travel component might appeal. Such a categorization may include demographic information such as income, age, gender, marital status, interests, hobbies, etc. Information may also be categorized by the other travel locations or activities to which the itinerary or travel component might relate (i.e., other destinations or activities that a person traveling to this location might like to do and that is in the general proximity). The processing element will then typically store the parsed, geo-coded, and categorized travel information in a database in storage element 14.

When a user desires to create a plan and book a trip, the user may enter a request (discussed in more detail below) via client 16 using user interface 22. Processing element 18 may transmit the request to the server 10 over network 23. In response to the user request, the processing element 12 of server 10 may access travel information corresponding to and satisfying the user request. The travel information would typically be accessed from storage element 14. The travel information is then typically transmitted by the server 10 to the client device 16, where the information is displayed for the user on the display element 20.

After reviewing the travel information, the user may select, such as via user interface 22, some portion of the displayed travel information, such as bookable components and non-bookable components or a complete itinerary, that the user desires to incorporate into an itinerary for the user's trip. The processing element 12 of server 10 will typically determine the price and availability of each component. Price and availability information will typically be obtained from a global distribution system (GDS) 26 or from data stored within the storage element 14. The various GDSs, such as Sabre, Amadeus, Galileo, and WorldSpan, act as middlemen to sell bookable travel components, such as airline tickets, through various customer channels, such as travel agencies and the travel planning websites. Additionally or alternatively, price and availability information may be obtained from a computerized reservation system (CRS) 28, such as the reservation system for an airline, car rental agency, or hotel chain. Price and availability information may also be obtained from the computer systems of individual travel component suppliers or vendors or any suitable provider of travel component pricing, availability, and reservations. Although price and availability information (and reservations for bookable travel components, as discussed below) may be obtained from many different sources, the use of GDSs and CRSs will be primarily discussed herein. The price and availability information will typically be transmitted from the server to the client device to be displayed for the user.

The processing element 12 of server 10 may suggest an optimized schedule for the selected components, based on a number of factors as described in more detail below. The optimized schedule would typically be displayed at the client device. When the user is satisfied with the user itinerary, the processing element 12 will then typically book the bookable items by transmitting information to a GDS 26 and/or to a CRS 28. The GDS 26 or the CRS 28 will typically create a reservation record, with each bookable component being a separate line item in the reservation record, and with non-bookable items included as remarks in the reservation record. After the user itinerary is completed, the processing element 12 will typically store the user itinerary in the storage element 14 for use as travel information for a future user request.

While FIG. 1 illustrates a system of one embodiment of the invention using a client/server configuration, it should be appreciated that the client/server configuration is shown for example purposes only and that the system of other embodiments of the invention could utilize configurations other than client/server. It should also be appreciated that the overall system architecture shown in FIG. 1 is for example purposes only, and not intended to limit the scope of the invention. Embodiments of the system of the invention could be implemented using a number of different system configurations.

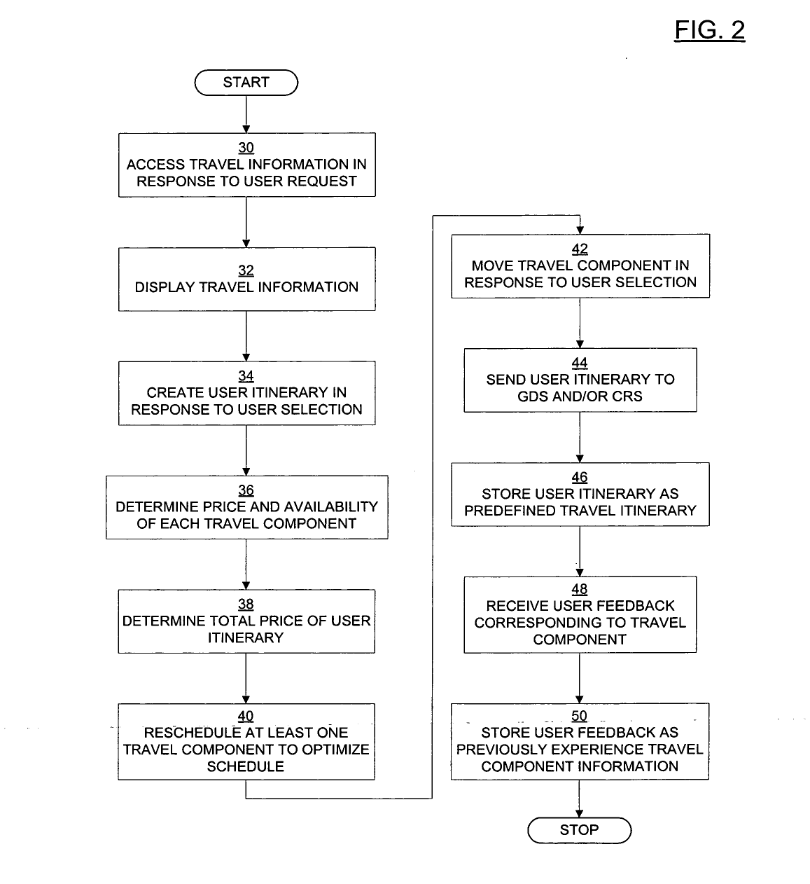

FIG. 2 is a flowchart of the operation of providing travel information, according to one embodiment of the invention. As discussed above, travel information that has previously been created by many different travelers may be obtained, such as by processing element 12 of server 10 of FIG. 1. The travel information will typically be parsed, geo-coded, categorized, and stored in a database in storage element 14. The travel information may then be accessed from storage element 14 in response to a user request. See block 30 of FIG. 2. The user request may be entered using many different methods and/or formats. In one embodiment, the request may be entered using one or more drop down lists. If two or more drop down lists are used then each successive list presented to the user will typically be more specific than the preceding list. For example, the user may be serially presented with a first list from which the user may select a continent, a second list from which the user may select a country within the selected continent, a third list from which the user may select a state or region within the selected country, and a fourth list from which the user may select a city within the selected state or region. The drop down lists may comprise geographic areas, as described above, travel type preferences (e.g., the user is presented with choices such as “active,” “scenic,” or “restful”), or types of activities (e.g., the user is presented with choices such as “beach,” “SCUBA diving,” or “wine tours”).

In an alternative embodiment, the request may be entered using a key word query, such that the user enters one or more words that are descriptive of the user's desired travel. For example, the user may enter the term “winery tour,” “Grand Canyon,” or “Ireland.” As another alternative, the request may be entered using a selection of a geographic area on a map. Two or more successive maps may be displayed, with each successive map enabling the user to select a more specific geographic area. For example, the user may be serially presented with a first map, such as a Mercator or other projection, from which the user may select a continent, a second map from which the user may select a country within the selected continent, a third map from which the user may select a state or region within the selected country, and a fourth map from which the user may select a city within the selected state or region (and the selected city or region would then typically be displayed on a fifth map). Each area of each map may include a clickable link to a successive map of the clicked area. Alternatively, a freeform selection tool may be provided such that the user may use a pointing device, such as a mouse, to draw a line forming a closed shape around the geographic area desired to select. The freeform selection tool may be used multiple times with successively more specific maps as described above.

The request may also be entered using a selection and placement (i.e., drag-and-drop) onto a map of an icon corresponding to a travel component category. The user will typically drag and drop the desired icon onto one of the more specific maps selected using one of the above described methods, such as the fifth map of the selected city (rather than, for example, the second map of the selected country which may provide too much information to be useful). The user will typically be presented with several different icons from which to select, with each icon representing a category of desired travel information. For example, the selectable icons may correspond to categories that include, but are not limited to, airplane travel, train travel, cruise ship travel, ferry travel, boat travel, bus travel, limousine travel, taxi travel, lodging accommodations, rental cars, restaurants, event tickets, exhibits, tours, entertainment activities, and sightseeing activities. Each selectable icon will typically have some visual aspect, such as shape, color, or text, which corresponds to the respective travel category.

Accessing the travel information typically comprises searching the travel information stored in the storage element 14 to retrieve travel information that matches the user's request. Travel information may be considered to match the user's request if, for example, the travel information has been assigned a geo-code that matches the geographic area selected by the user. A single item of travel information may have multiple geo-codes of varying specificity. For example, travel information regarding a particular winery tour may have several geo-codes, such as “Yountville,” “Napa Valley,” “Northern California,” “California,” “West Coast of United States,” and “United States.”

The travel information that has been accessed from the server may then be transmitted to a client device 16 such that the information can be displayed on a display element 20. See block 32. The travel information may be displayed in many different formats. Regardless of the display format, however, the displayed information will typically be selectable by the user to enable the user to drag and drop one or more travel components into a virtual shopping cart to create a user travel itinerary, as discussed in more detail below, although the user may make a selection using any suitable selecting mechanism. As discussed above, the travel information may comprise complete travel itineraries created by other travelers and/or information about discrete travel components, typically obtained from travel journal entries. A list of journal entries and/or predefined travel itineraries may be displayed, such as using a tree structure that enables the user to “drill down” into each itinerary or journal entry to view all of the individual travel components within each itinerary or journal. A display window may also be provided in which details of a selected component within a journal entry or itinerary may be displayed. Photos from a selected component within a journal entry or itinerary may be displayed. Alternatively, if no travel component is selected then photos from one or more of the highest rated journal entries or itineraries may be displayed. Additionally, an icon may be displayed on a map showing the location of selected component within a journal entry or itinerary. Several icons may be displayed on the map if the user has selected an entire journal entry or itinerary containing several travel components. If no individual travel components and no entire journal entries or itineraries have been selected, icons may be displayed on the map corresponding to the locations of the travel components with the highest rated journal entries or itineraries. The icons displayed on the map may be any suitable visual indicator, including but not limited to drawings, photographs, symbols, letters, and numbers.

After reviewing the displayed travel information, the user may select some portion of the displayed travel information, such as bookable components, non-bookable components, a complete itinerary, or a portion of an itinerary that the user desires to incorporate into an itinerary for the user's trip. The user typically will drag and drop the desired travel component into a virtual shopping cart. The user may select an entire predefined travel itinerary, or a portion thereof, from the tree structure. The user may select all of the travel components corresponding to a day of travel in a predefined travel itinerary, typically by selecting the day of travel (e.g., “Day 1”). The user may select a bookable travel component or a non-bookable travel component from within a journal entry displayed in the tree structure, typically by selecting the name of the travel component (e.g., “Alcatraz Tour”). The user may select an icon on the map corresponding to a desired travel component. The user may select a photograph, a website link, and/or a product or service menu corresponding to a desired travel component. Generally, any item can be dragged to the shopping cart as long as the item is selectable (i.e., clickable) and can be displayed, in some form, on a user interface. Display items are not limited to text listings, maps, or images.

After all the desired travel components are selected and placed in the virtual shopping cart, each travel component would then typically be selected by the user to be scheduled into at least one day of travel. As the user selects each desired travel component, the user may drag and drop each travel component into a specified day of travel and a specified time within that day. The user's selection (i.e., travel components and associated day/time) is typically transmitted from the client device to the server, such that the processing element 12 may create a user travel itinerary in response to the user's selections. See block 34 of FIG. 1. The created user itinerary comprises the selected travel components with an indication of which travel component is desired on which day of travel.

The processing element 12 will then typically determine the price and availability of each travel component in the user itinerary, including both the bookable and non-bookable components. See block 36 of FIG. 2. Price and availability information will typically be obtained from a global distribution system (GDS) 26, from a CRS 28, or from data stored within the storage element 14. The price and availability information will typically be transmitted from the server to the client device to be displayed for the user. The processing element will typically provide a total price of all components within the user itinerary, by summing the price of the individual travel components. See block 38. Ideally, in order to provide accurate availability information, the user will have already provided the user's actual dates of travel. If the user has not provided the actual dates of travel, the processing element may determine availability based on assumed dates of travel. The assumed dates of travel may be based on the average number of days in advance that typical travelers book travel components. If the availability is based on assumed dates of travel, the processing element will typically re-determine availability when the user provides the user's actual dates of travel. The user would typically need to provide the actual dates of travel prior to booking the bookable components.

The processing element 12 may then suggest the reschedule of at least one travel component to optimize the schedule. See block 40. The schedule may be optimized based on a number of factors such as the number of days of travel, the number of travel components selected, the length of time required for each travel component, the rating of each selected travel component, the availability of each selected travel component, the total price of the user itinerary, the total price of the user itinerary compared to a user budget, the travel time required between each travel component, the geographic location of each travel component, and the desired amount of free time. For example, the processing element would determine if each travel component is scheduled only on a day and time at which that component is available (e.g., based on days/hours of operation). The processing element 12 may determine that travel components located in close geographic proximity are scheduled on the same day to minimize travel time. The schedule may also be optimized based on predefined user preferences. For example, the user may indicate a desire to include as many of the selected travel components in the final itinerary as possible. As such, the processing element 12 may determine if more travel components could be scheduled if one or more travel components were rescheduled. The optimized schedule would typically be displayed at the client device.

After reviewing the optimized schedule, the user may desire to change the schedule. The user will then typically select one or more travel components and indicate the desired alternative day and/or time of travel for the selected component(s), thus causing the processing element 12 to move the selected component(s). See block 42. A selected component may be moved from one day of travel to a different day or from one time to a different time on the same day of travel. A selected component may be removed from the schedule to provide free time for the user to rest. If a selected component is moved to a different day, the processing element would typically provide some indication to the user as to whether the component is available on the newly selected day and/or time.

When the user is satisfied with the user itinerary (both the selected travel components and the scheduled days and times for each selected travel component), the user may indicate a desire to secure reservations/tickets for (i.e., to “book”) the bookable items. The user would typically have to arrange for payment, such as by providing a credit card number and expiration date. The processing element 12 will then typically book the bookable items by transmitting the user itinerary to a GDS and/or to a CRS. See block 44. The GDS or CRS will typically create a reservation record, with each bookable component being a separate line item in the reservation record, and with non-bookable items included as remarks in the reservation record. Where the reservation record is created by a GDS or an airline CRS, the reservation record is typically termed a passenger name record (PNR). After the user itinerary is completed, the processing element 12 will typically parse, geo-code, categorize, and store the user itinerary in the storage element 14 for use as a predefined travel itinerary for a future user request. See block 46.

The user itinerary may also continue to be accessible by the user, such as via a Uniform Resource Locator (URL) on the Internet, to be used as an online travel journal. After the user completes the planned trip, the user may enter feedback corresponding to one or more travel components of the user's trip. See block 48. This feedback may comprise textual, audio, or video descriptions, reviews, suggestions, tips, photographs, website links, product or service menus (e.g., restaurant menu), and/or ratings of travel components. The processing element 12 will typically parse, geo-code, categorize, and store this user feedback in the storage element 14 for use as previously experienced travel component information for a future user request. See block 50. In one embodiment, the user feedback may be stored in the reservation record created by the GDS or CRS.

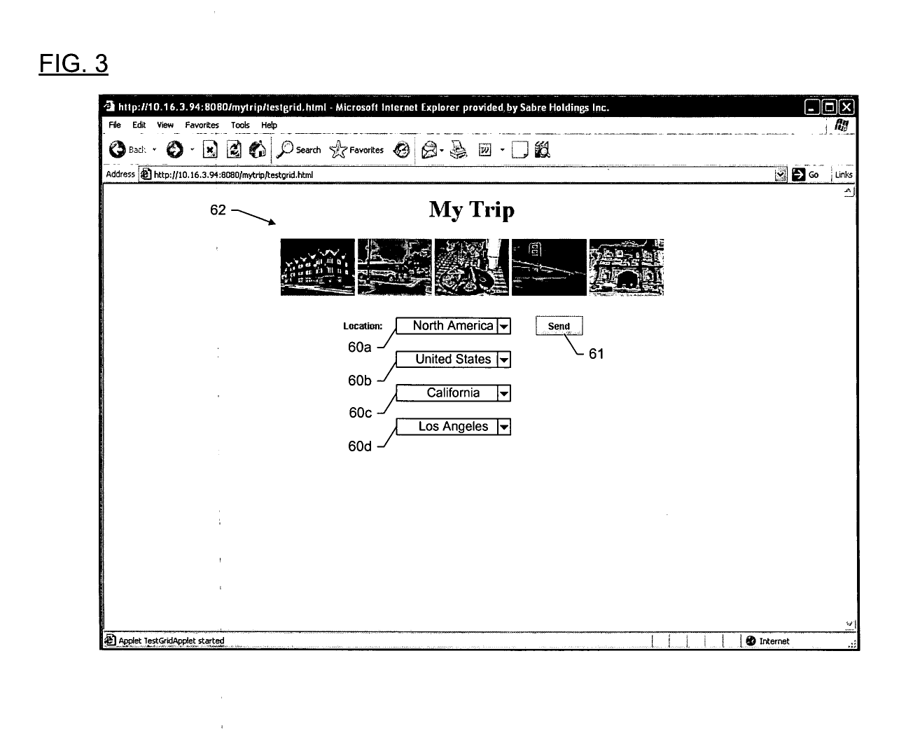

FIGS. 3-21 provide examples of displayed views of a graphical user interface (GUI), commonly referred to as screen shots, which a user of embodiments of the invention may access and interface with when using the invention. The screen shots illustrated in FIGS. 3-21 would typically be accessed via the Internet by a user using a client device, such as the client device 16 of FIG. 1. Referring now to FIG. 3, a screen shot of a request entry screen for entering a user request is illustrated, according to one embodiment of the invention. The user may access the screen illustrated in FIG. 3 in many different ways. The user may have been accessing an online travel journal to read about various vacation destinations and then selected an Internet link to access an embodiment of the invention. Alternatively, the user may have been researching price and availability of individual travel components using a travel planning website, such as Travelocity, Expedia, or Orbitz, desired to obtain information about travel destinations and possible itineraries from previous travelers, and thus selected an Internet link to access an embodiment of the invention.

Once the user has accessed an embodiment of the invention, the user may enter a request for travel information using many different-methods and/or formats as discussed above. In one embodiment, the user may enter a request using one or more drop down lists as illustrated in FIG. 3. The user may select a continent from drop down list 60a, a country from drop down list 60b, a state from drop down list 60c, and a city from drop down list 60d. As is known in the art, as each selection is made from a drop down list the selections presented to the user in successive drop down lists will typically change. Thus, when the user selects “North America” from drop down list 60a, the list of countries presented in drop down list 60b will typically change and will only include North American countries. Similarly, when the user selects “United States” from drop down list 60b, the list of countries presented in drop down list 60c will typically change and will only include U.S. states. FIG. 3 also illustrates the display of several photographs 62 of travel destinations. The user may select any one of the photographs to obtain information regarding the destination depicted in the photograph. These photographs may depict randomly selected travel destinations or popular travel destinations.

After the user has made a selection from each one of the drop down lists on FIG. 3 (or after the user has selected one of the photographs), the display may advance automatically to the next screen. Alternatively, the user may be required to select (such as by “clicking” with a mouse) the “Send” button 61 to advance to the next screen. As an alternative to the drop down lists as illustrated in FIG. 3, and as discussed above, the user may enter a request using a selection of a geographic area on a map. Two or more successive maps may be displayed, with each successive map enabling the user to select a more specific geographic area.

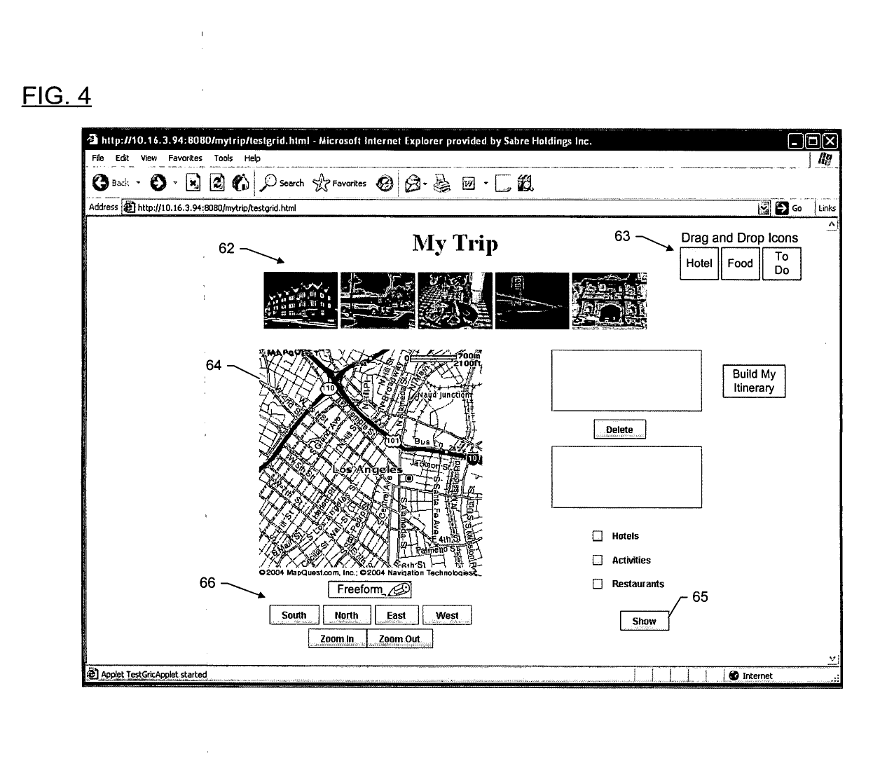

Referring now to FIG. 4, a screen shot of a screen capable of accepting entry of a further user request or displaying the results from the user request is illustrated, according to one embodiment of the invention. The screen illustrated in FIG. 4 may be displayed after the user has submitted a request for information regarding travel to Los Angeles, such as by using the drop down lists illustrated in FIG. 3. The screen of FIG. 4 comprises a map 64 of the selected geographic area, and navigation buttons 66 to modify the geographic area displayed by the map. If map 64 shows the area for which the user desires travel information, the user may request that the information be displayed on the screen. The user may do this by clicking on the “Show” button 65, thereby causing travel information corresponding to the area displayed on the map to be displayed as described below. If the user desires to see travel information regarding a specific category of travel component (e.g., hotel accommodations, rental cars, restaurants, sightseeing activities), the user may drag and drop an icon corresponding to the desired category onto the displayed map. FIG. 4 illustrates icons 63 for three categories: hotel, food, and activities. The photographs displayed in FIG. 4 would typically correspond to travel components available in the area displayed on map 64. The user may select one of the photographs to display travel information regarding the travel component depicted. The user may also be able to move a computer cursor over an icon (termed a mouse-over) or click on an icon to produce indicators on a map where bookable, and/or non-bookable previously experience travel components exist. Such an indicator could be highlighting, color-coding, or an icon/symbol. For example, a user may click on or mouse-over a “golf” icon, thereby causing an indicator to be displayed on each location on the map where there is a one golf course.

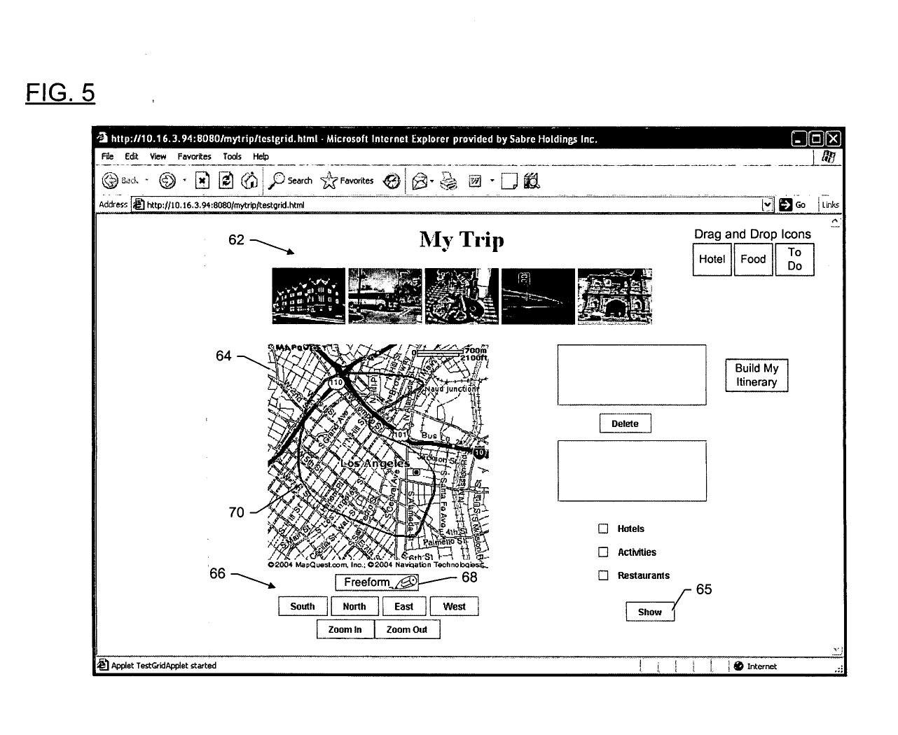

The user may not desire to see travel information for the entire geographic area displayed on map 64. As such, the user may restrict the requested information by selecting a portion of the area displayed on the map. Referring now to FIG. 5, a screen shot of a request entry screen for further restricting a user request is illustrated, according to one embodiment of the invention. A freeform selection tool may be used to limit the geographic area for which travel information is displayed. To restrict the area, the user may select a “Freeform” button 68 and then may use a pointing device, such as a mouse, to draw a line forming a closed shape 70 around the geographic area of interest. This limits the user request to the geographic area within the closed shape drawn by the user. After the user has drawn the closed shape 70, the display may advance automatically to the next screen. Alternatively, the user may be required to select the “Show” button 65 to advance to the next screen.

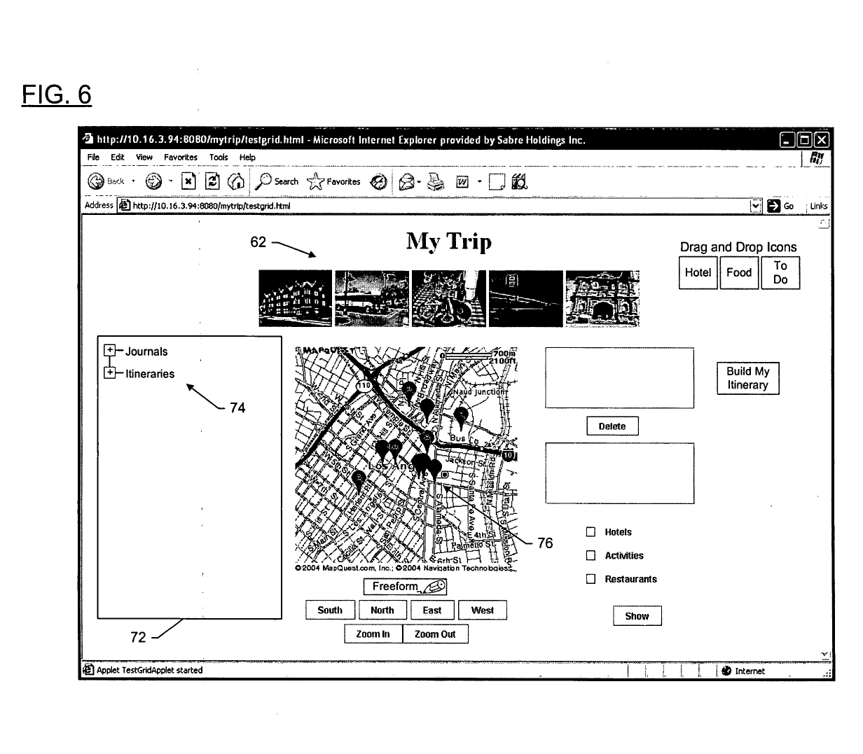

Referring now to FIG. 6, a screen shot of results from a user request is illustrated, according to one embodiment of the invention. The travel information displayed in FIG. 6 is illustrative of results from a user request for travel information obtained from other travelers (in this case, for information relating to travel to Los Angeles). The travel information may comprise complete travel itineraries, either from completed trips or from planned but not yet completed trips, and information about discrete travel components separate from a complete travel itinerary, such as may be obtained from travel journal entries. The travel journal entries and the trip itineraries would typically be accessed from a database stored in storage element 14 of FIG. 1 by matching key words and geo-codes in the user request and the stored travel information. The travel journal entries and the trip itineraries may be displayed in a tree structure 74 within a display window 72. As there may be a very large number of journal entries and trip itineraries available to display, embodiments of the invention may use a rating system to limit the number of journal entries and/or trip itineraries that are displayed, such that only the top rated entries and itineraries may be displayed. Each journal entry and each trip itinerary may be rated, such as by editors and/or readers of an online travel journal. The display of journal entries and trip itineraries presented to users may also be limited or filtered according to user preference settings, such as from a user profile, or according to user inputs. User inputs could take many forms, such as a checkbox to sort items according to defined parameters (e.g., a star rating) or based on user demographics (e.g., age, gender, location, marital status, income, etc.). The user may indicate, for example, that only three star or higher hotels should be displayed, thus preventing the display of journal entries or trip itineraries describing or containing one or two star hotels. Or the user may indicate, for example, that only journal entries or trip itineraries describing trips taken by single women between the ages of 20 and 29 should be displayed. The ability to filter the display based on the demographics of the previous traveler may be available to the user, if the previous traveler has provided such demographics and authorized the exposure of such information. FIG. 6 also illustrates the display of icons 76 on the map. Each icon typically corresponds to the geographic location of an individual travel component within a journal entry or a trip itinerary. Each icon may have a visual aspect (e.g., color, shape, symbol, or text) corresponding to the travel category of the travel component. The number of icons displayed on the map may be limited, such as by only displaying icons corresponding to the ten top rated travel components, to enable the user to readily distinguish each individual icon. The photographs 62 that are displayed may change to depict locations or activities that correspond to the user request. In one embodiment of the invention, if the user selects one of the photographs, travel journal entries and/or itineraries that correspond to the photograph may be viewed in the display window 72.

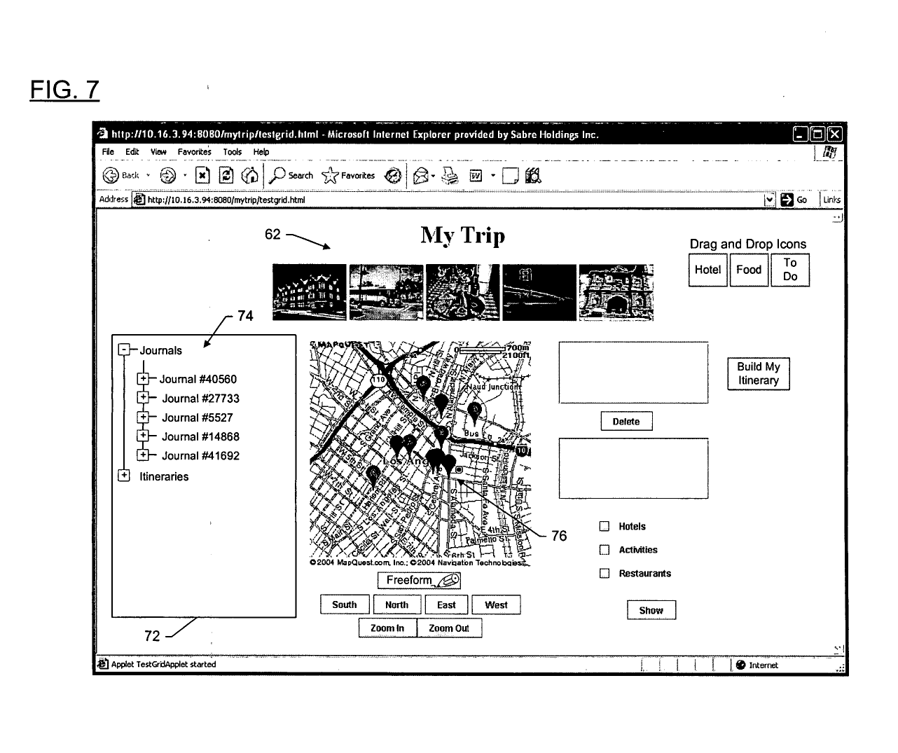

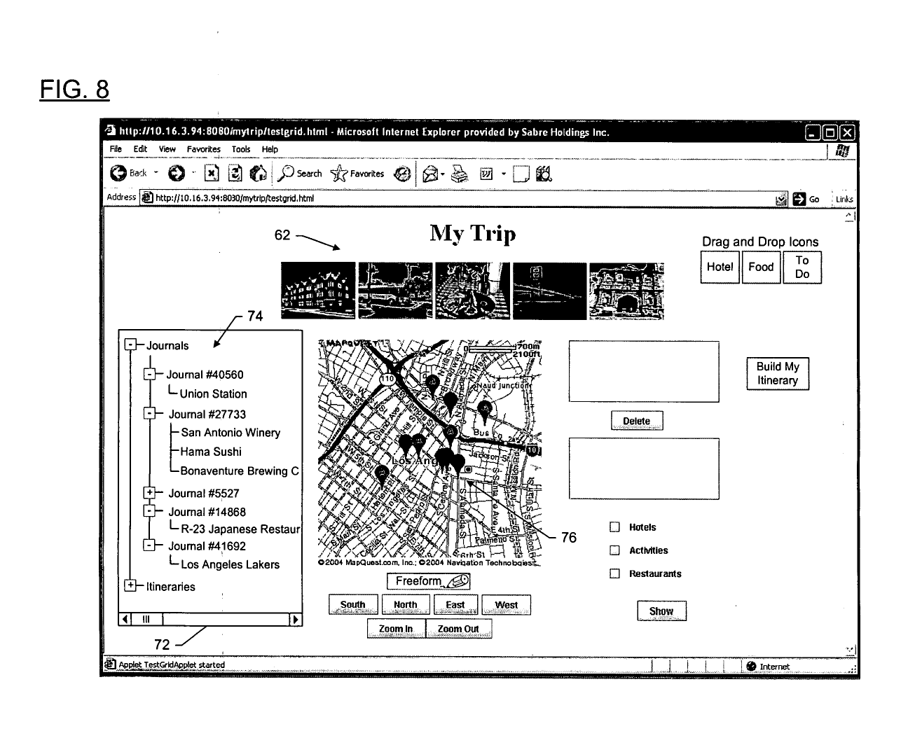

Referring now to FIG. 7, a screen shot of results from a user request is illustrated, according to one embodiment of the invention. FIG. 7 illustrates “drilling down” within the tree structure 74 to display the journal entries which match the user request and which are available to display and select. In this example, there are five journal entries. FIG. 8 illustrates “drilling down” further into four of the journal entries within the tree structure to display the specific travel components described in each journal entry. For example, Journal #40560 describes Union Station, while Journal #41692 describes the Los Angeles Lakers. In addition to the name of a travel component within each journal entry, additional information (e.g., the author's name, age, gender, location, marital status, profession, interests, hobbies, etc.) may be displayed to help the user decide which journal entries to view.

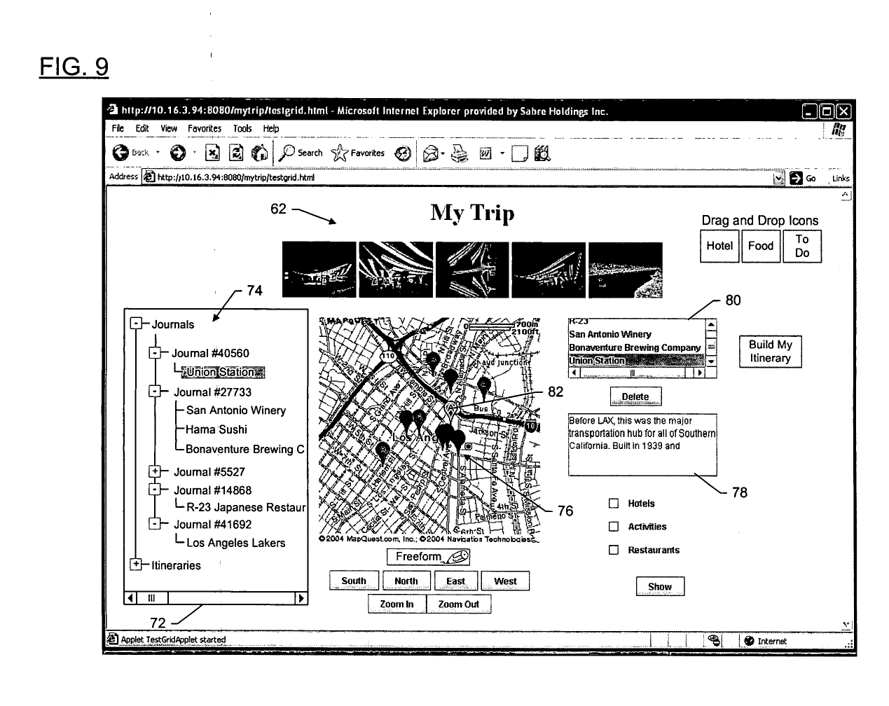

FIG. 9 illustrates the display of information contained within a travel journal entry. The user may highlight (by clicking on with a mouse) a travel component (Union Station in this example) within a journal entry to display the available information. The information available within that journal entry may be displayed in display box 78. In a journal entry, this information may contain a textual description written by the journal author, links to one or more websites where additional information is available, and scanned images related to the travel component (e.g., a restaurant menu). Additionally, any photographs available in the highlighted journal entry may be displayed in the photograph display area 62. Although difficult to see in a black and white figure, the visual aspect of the icon 82 corresponding to the highlighted travel component may be changed (e.g., to a different color) to enable the user to quickly identify its location on the map. The user may also select one of the displayed icons to cause the display in the display box 78 of the information available regarding the corresponding travel component.

FIG. 9 also illustrates the selection and placement (i.e., drag and drop) of individual travel components from journal entries into a shopping cart 80. As illustrated, four travel components have been selected by the user and placed in the shopping cart 80. The user may drag and drop a travel component name from the tree structure, a photograph of a desired travel component, or a map icon of a desired travel component into the shopping cart.

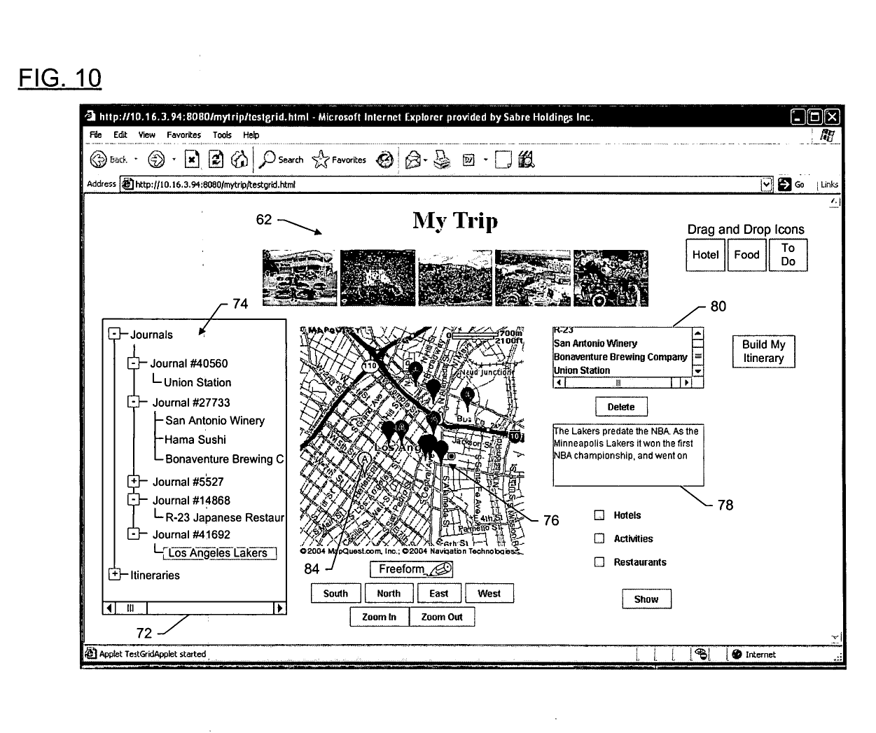

Similar to FIG. 9, FIG. 10 illustrates the display of information contained within a highlighted travel journal entry, according to one embodiment of the invention. In this figure, the user has highlighted a different travel component (“Los Angeles Lakers”) in the tree structure, thus causing different information to be displayed in the display box 78 and the visual aspect of icon 84 (corresponding to the highlighted travel component) to be changed.

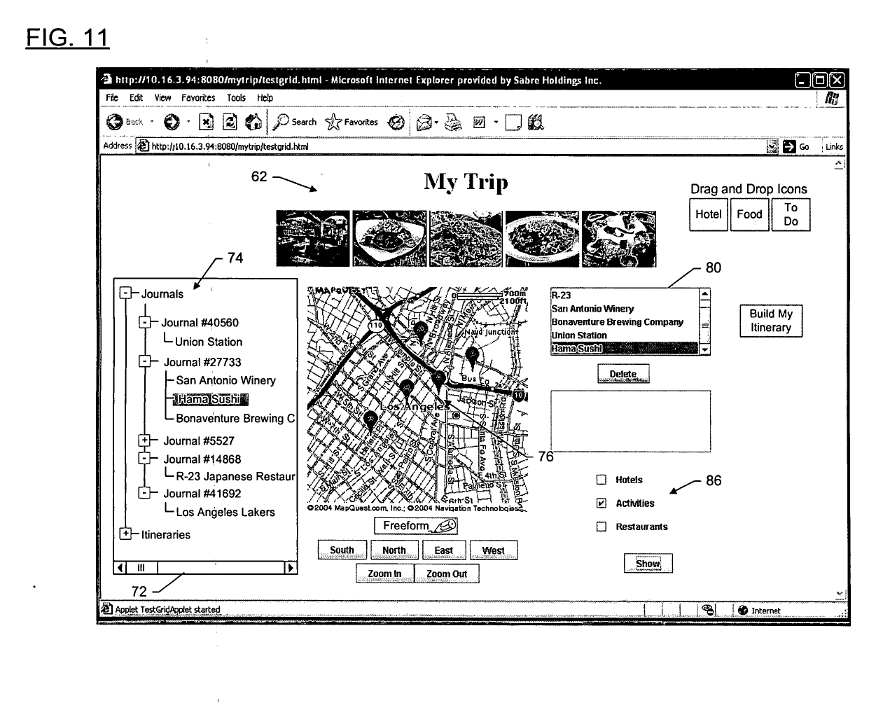

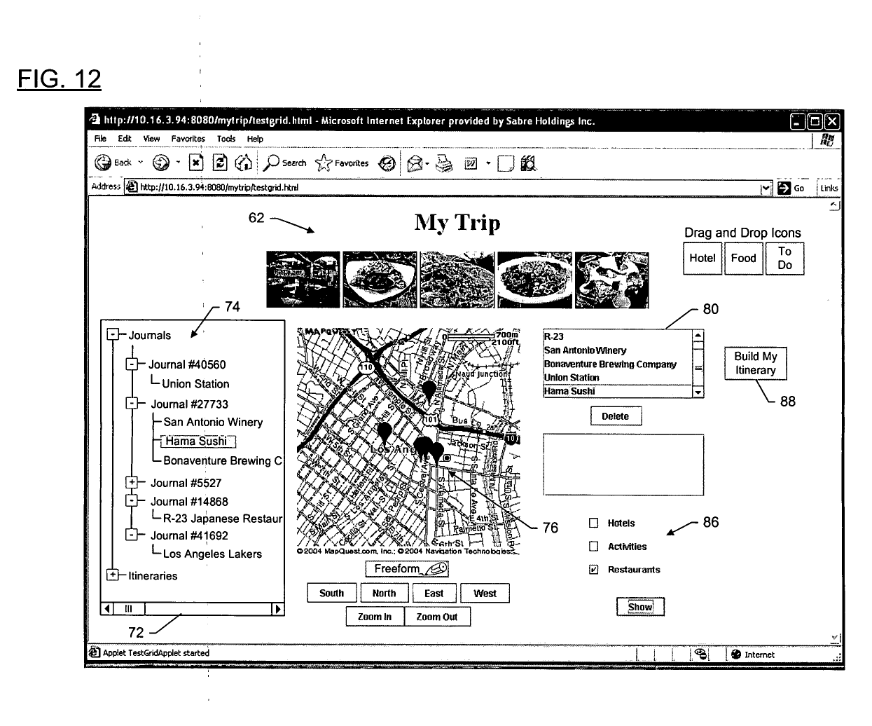

FIG. 11 illustrates a tool for reducing the amount of information displayed on the map, according to one embodiment of the invention. The category selection tool 86 enables a user to select a travel component category, such that only the icons corresponding to travel components within the selected category may be displayed on the map. FIG. 11 illustrates three travel categories (hotels, activities, and restaurants) from which to select, however many more selections could be provided. FIG. 11 illustrates the selection of the activities category, such that only icons corresponding to travel components which have been categorized as activities are displayed on the map. Similarly, FIG. 12 illustrates the selection of the restaurant category, such that only icons corresponding to travel components which have been categorized as restaurants are displayed on the map. The user may then click on one of the displayed icons and view the information for the corresponding travel component. Thus, the category selection tool enables a user to quickly view the information available for travel components within a particular category, without having to search through multiple journal entries.

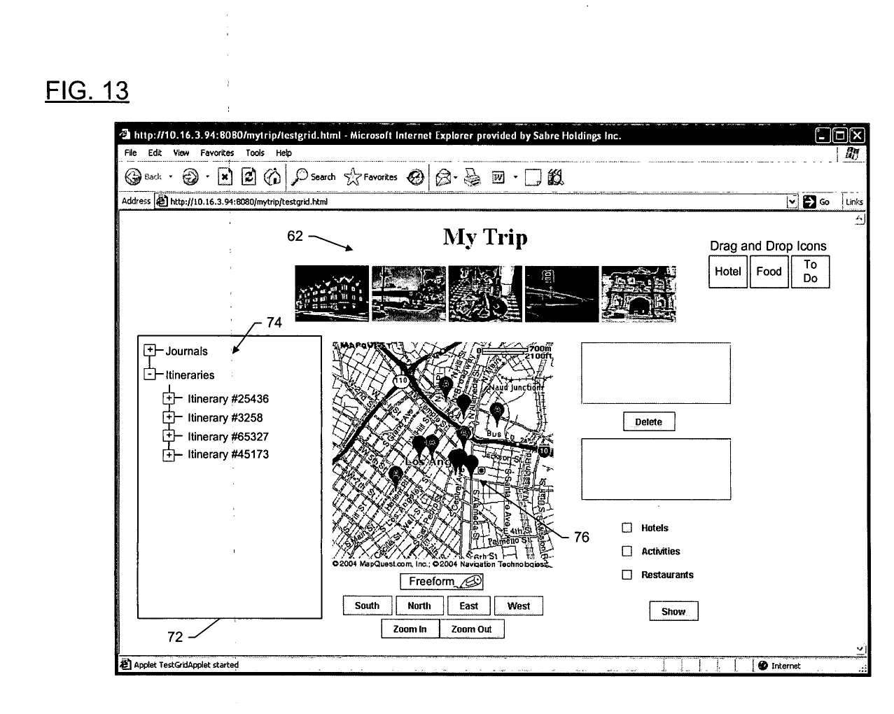

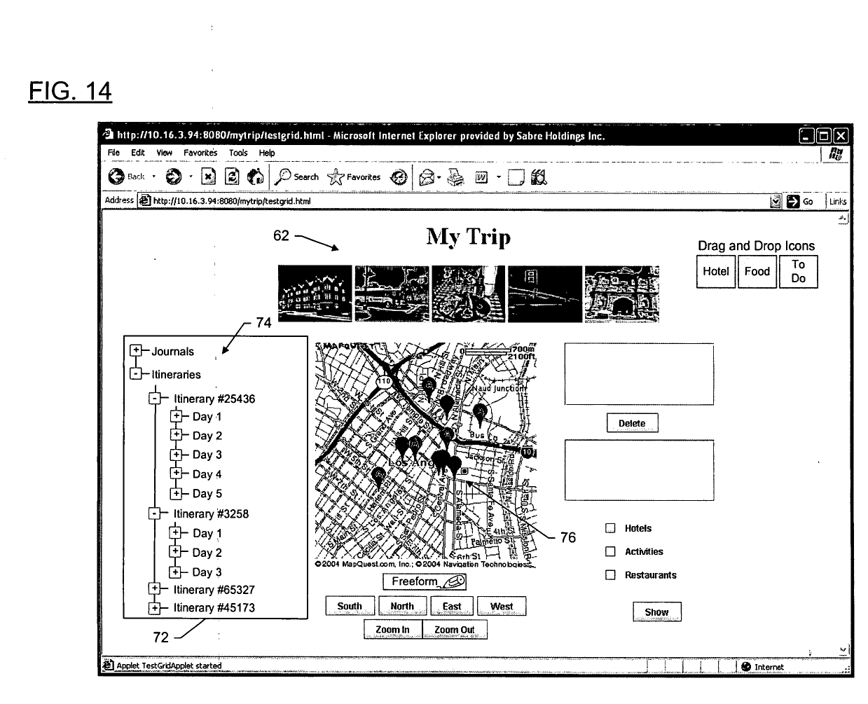

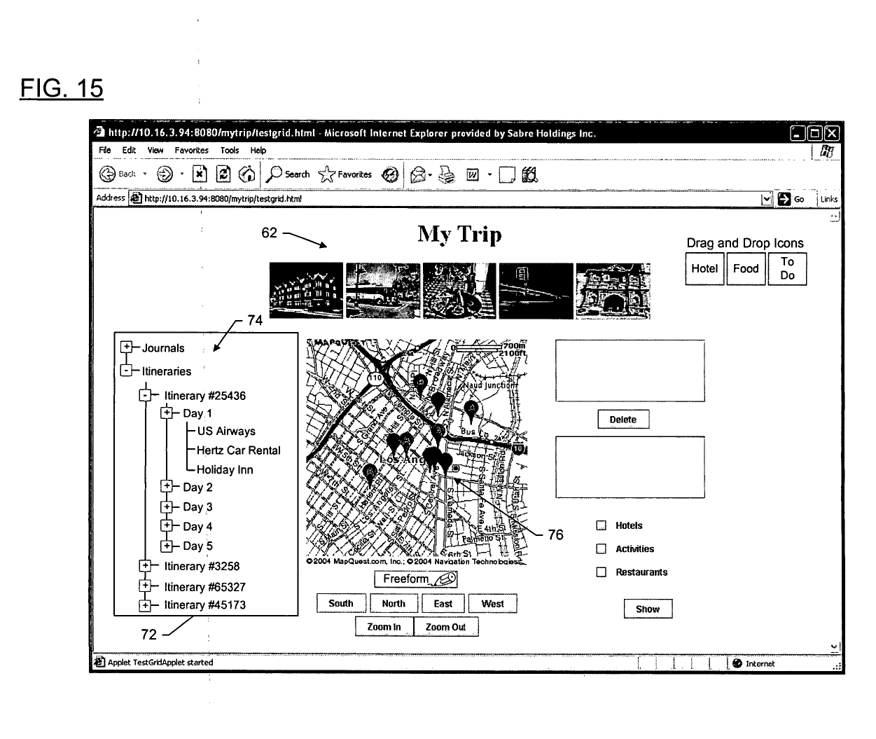

Similar to FIG. 7, FIG. 13 illustrates “drilling down” within the tree structure 74 to display the trip itineraries which match the user request and which are available to display and select. In this example, there are four trip itineraries. FIG. 14 illustrates “drilling down” further into two of the trip itineraries within the tree structure to display the days of travel described in each trip itinerary. For example, Itinerary #25436 is a five day trip, while Itinerary #3258 is a four day trip. FIG. 15 illustrates “drilling down” further into one of the travel days of one of the trip itineraries within the tree structure to display the specific travel components described in that day of travel.

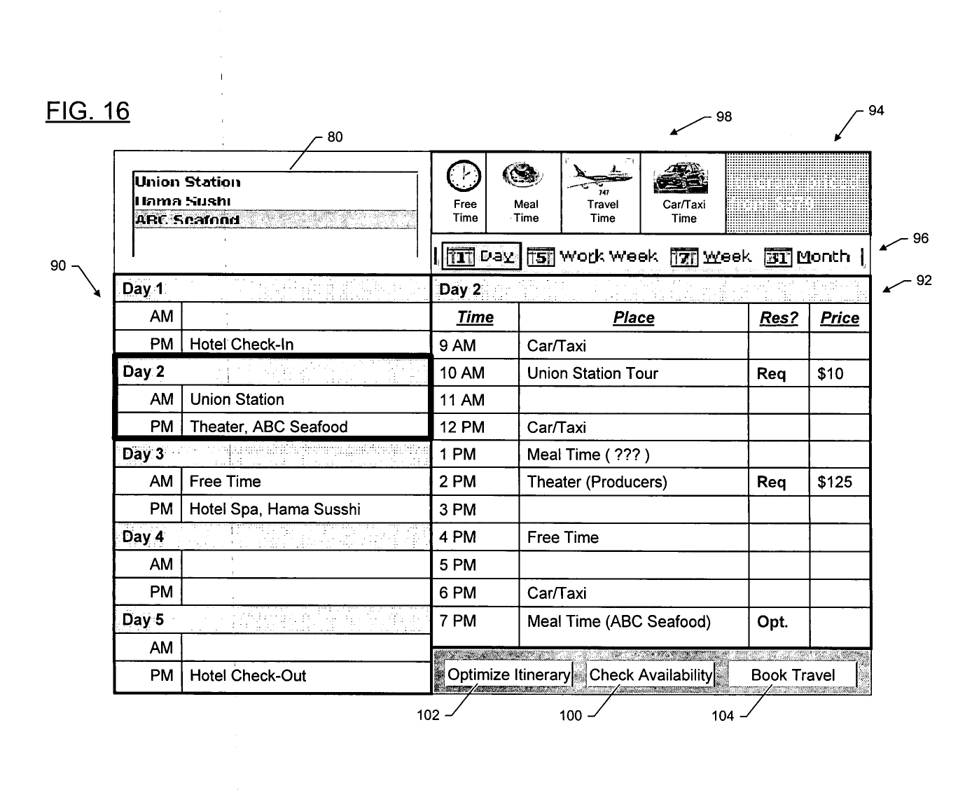

Referring back to FIG. 12, when the user has selected the desired travel components, such as by dragging and dropping travel component names from the tree structure, photographs, or map icons into the shopping cart, the user may then request that a user itinerary be created, such as by selecting the “Build My Itinerary” button 88. When the “Build My Itinerary” button 88 is selected, the user will typically be prompted to input some information that may be required or useful to create the user itinerary (this prompting for information is not illustrated). For example, the user would typically be prompted to input the desired length of the trip (the user may either input the desired number of days of travel or may input departure and return dates) and the departure city. A user itinerary creation screen may then be displayed. Referring now to FIG. 16, the creation of a user itinerary is illustrated, according to one embodiment of the invention. The user itinerary creation screen may display the shopping cart 80 containing the travel components previously selected by the user. The user itinerary creation screen may also include a scheduler window 90. In the illustrated embodiment, the scheduler window 90 is divided into days of travel (“Day 1,” “Day 2,” etc.), and each day of travel is divided into morning (“AM”) and afternoon (“PM”) time periods. The user may drag and drop a travel component from the shopping cart and onto the desired travel day and time period. Additionally, if one or more complete travel days from a previous trip itinerary, or a complete previous trip itinerary, have been placed in the shopping cart by the user, then the travel components within those previous trip itinerary travel days may be automatically placed into a day of travel in the scheduler window 90 based on each component's day of travel in the previous trip itinerary.

After the user has placed all of the desired travel components into a day of travel, or after the user has placed a particular day's desired travel components into that day of travel, the user may then schedule the travel components into more specific time slots by using the calendar window 92. The user may select a day of travel (Day 2 is selected in this illustration) to see a detailed day planner schedule for that selected day within the calendar window. Each travel component that has previously been placed into the selected day in the scheduler window 90 may be scheduled by the user for a specific time. For example, FIG. 16 illustrates the user scheduling the Union Station tour for 10:00 AM and the theater for 2:00 PM. Although FIG. 16 illustrates a day planner schedule that is divided into one hour time slots, other divisions (e.g., half hour time slots) may be provided. In one embodiment of the invention, some of the selected travel components may be automatically scheduled into a specific time slot based on the time the component is offered. For example, if the selected theater show is only shown at 2:00 PM, then the show may be automatically scheduled into the 2:00 PM time slot.

The user may reschedule travel components within the calendar window by dragging and dropping a travel component from one time slot to another time slot. The user may also provide time in the user itinerary for free time, meals, and/or travel by dragging and dropping a placeholder icon 98 into a time slot in the calendar window. For example, FIG. 16 illustrates the user scheduling time for car/taxi travel at 9:00 AM, 12:00 PM, and 6:00 PM. The calendar window typically displays a price for each travel component for which pricing information is available, including both bookable and non-bookable travel components. The calendar window may also display an indication of whether each scheduled travel component requires a reservation. The user itinerary creation window would also typically include a display 94 of the lowest available price for the total user itinerary. The final price for particular travel components, such as airline tickets, may vary depending on the final schedule of the user itinerary. As such, the total user itinerary price displayed will typically use the lowest available price for those components for which a final price is not yet available. The total itinerary price will typically include all bookable travel components, and those non-bookable travel components for which pricing information is available.

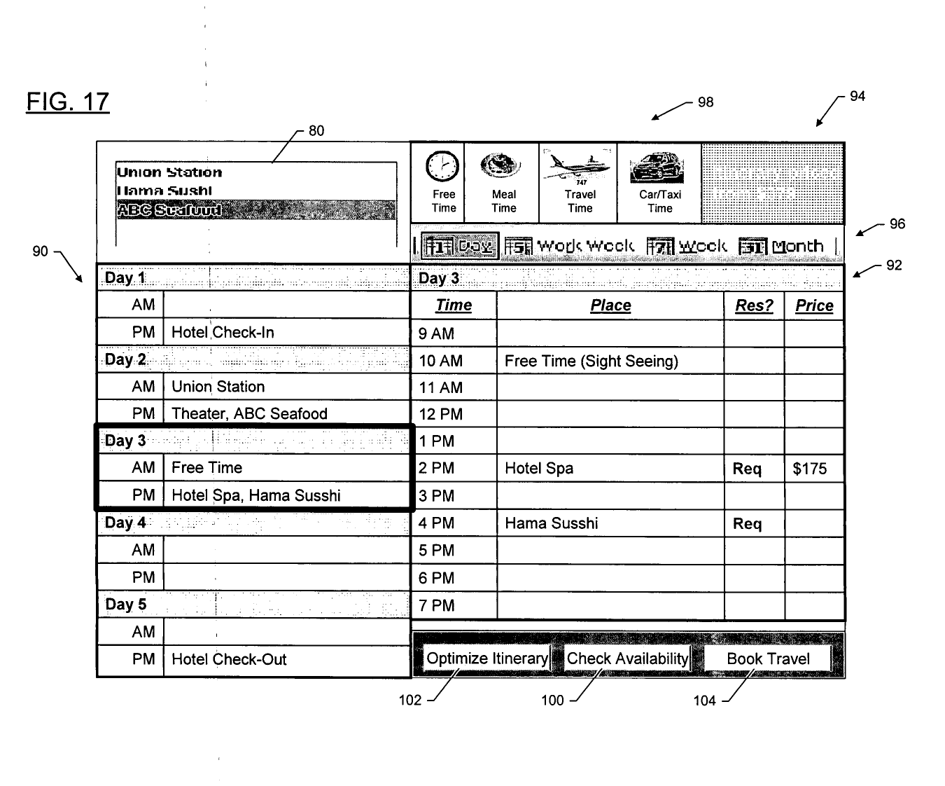

Similar to FIG. 16, FIG. 17 illustrates the user itinerary creation screen, according to one embodiment of the invention. In FIG. 17, travel Day 3 is highlighted within the scheduler window 90, thus enabling the user to schedule the Day 3 travel components into specific time slots. FIG. 17 also illustrates the ability to add comments to scheduled travel components or to placeholders in the schedule. The user has scheduled the placeholder “Free Time” at 10:00, and has added a comment (“Sight Seeing”) to the placeholder.

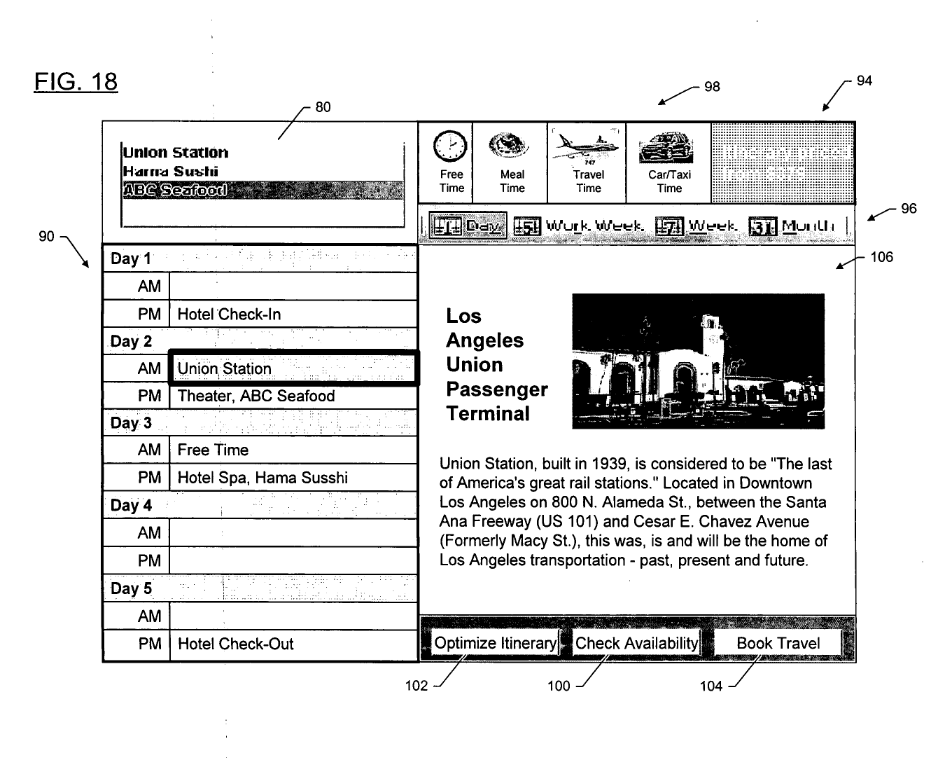

FIG. 18 also illustrates the user itinerary creation screen, according to one embodiment of the invention. In FIG. 18, the user has highlighted a specific travel component (“Union Station”) within the scheduler window 90. By doing so, the day planner schedule in the calendar window is replaced by information 106 regarding the highlighted travel component. The displayed information may be, for example, from the highest rated travel journal entry describing the highlighted travel component. The user may be making decisions as this point as to whether to delete a particular travel component from the user itinerary (e.g., to resolve a scheduling conflict), and it may be helpful to the user to view this information without returning to a prior screen.

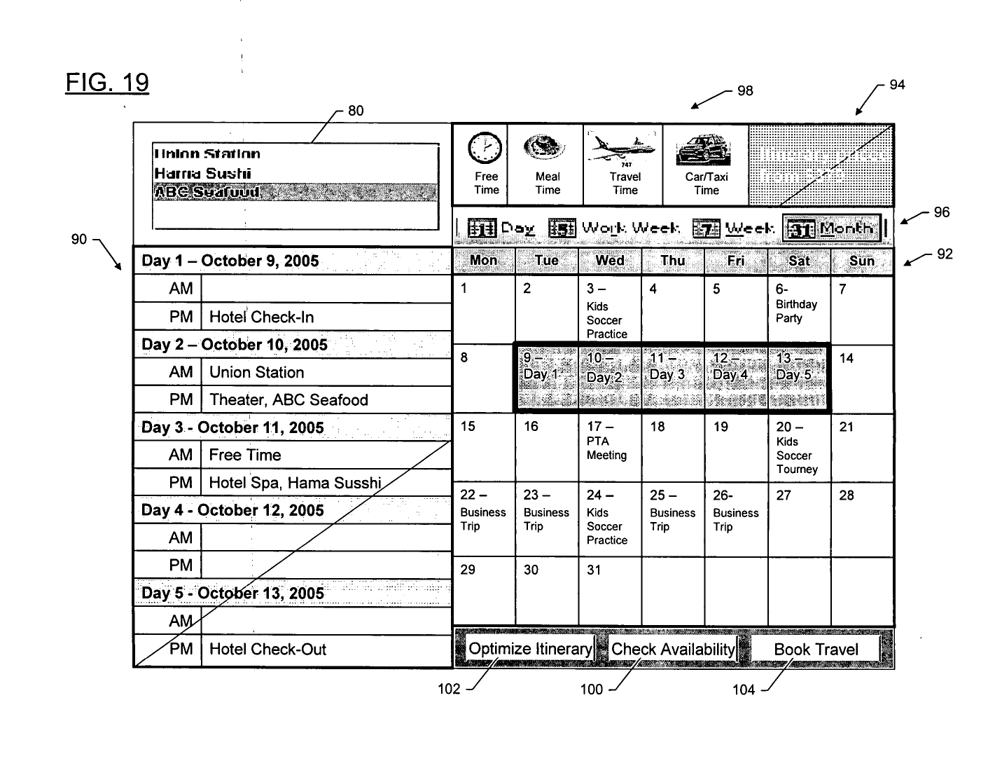

FIG. 19 also illustrates the user itinerary creation screen, according to one embodiment of the invention. In FIG. 19, the user has selected the monthly view in the calendar window by using the calendar view selection buttons 96. The monthly calendar displayed in the calendar window may be linked to a separate calendar application (e.g., Microsoft Outlook), thereby enabling the user to view the planned trip in relation to the user's existing scheduled activities. If the user has previously entered the desired departure date and the return date for the planned trip, these entered dates would typically be used to display the planned trip in the appropriate days of the monthly calendar view. If the user has not previously entered the desired departure and return dates, the user may drag the first day of the trip from the scheduler window 90 into a specific day in the monthly calendar view, thereby also causing the remaining days of the trip to be automatically displayed in the appropriate subsequent days of the monthly calendar view. In the illustration of FIG. 19, the user's planned five day trip is displayed beginning on the 9th day of the displayed month and ending on the 13th day of the displayed month. In one embodiment of the invention, processing element 12 may determine alternative dates for the scheduled trip based on pricing of travel components, availability of travel components, or conflicts with other activities in the user's calendar.

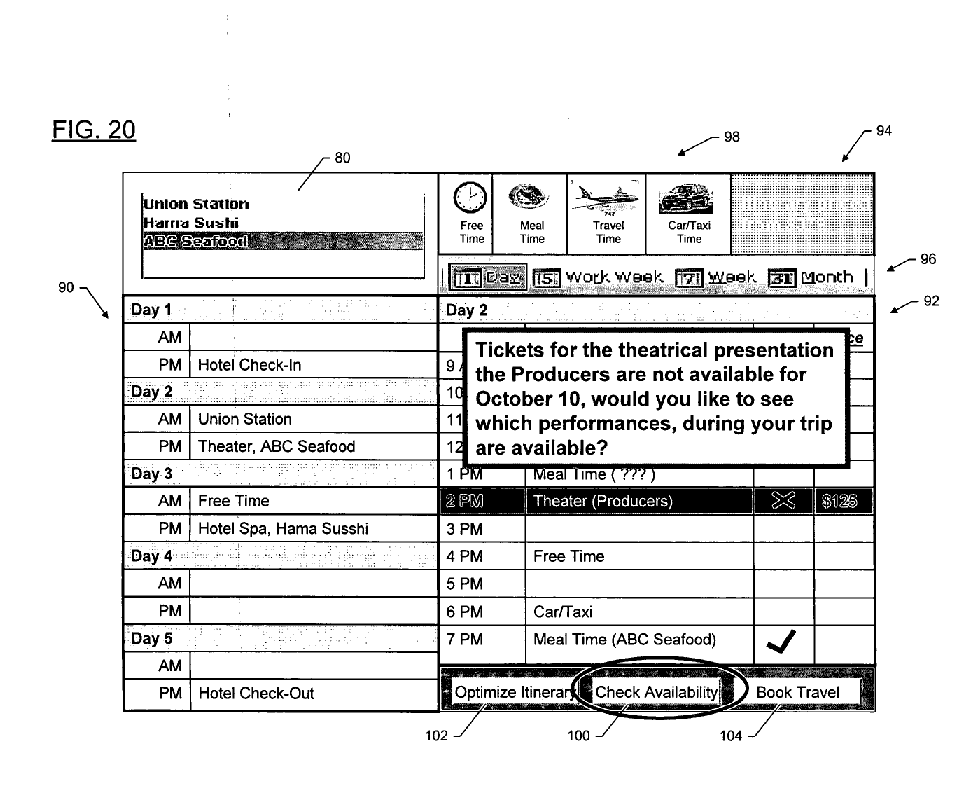

FIG. 20 also illustrates the user itinerary creation screen, according to one embodiment of the invention. In FIG. 20, the user has selected the “Check Availability” button 100. With each travel component scheduled into a date and time, the server 10 can communicate with the GDS 26 and/or with the CRS 28 to determine the availability of each bookable travel component. The processing element 12 may also access information stored in the storage element 14 regarding the hours of operation of each non-bookable travel component to determine availability. The availability status of each travel component will typically be displayed. As illustrated in FIG. 20, the processing element 12 may cause a message to be displayed to notify the user of the lack of availability of a travel component, and may check for availability of that travel component on a different day and/or time. If the travel component is available on a different day and/or time, the user may reschedule the travel component by dragging and dropping to the different day and/or time, or the processing element 12 may automatically reschedule the travel component to the different day and/or time.

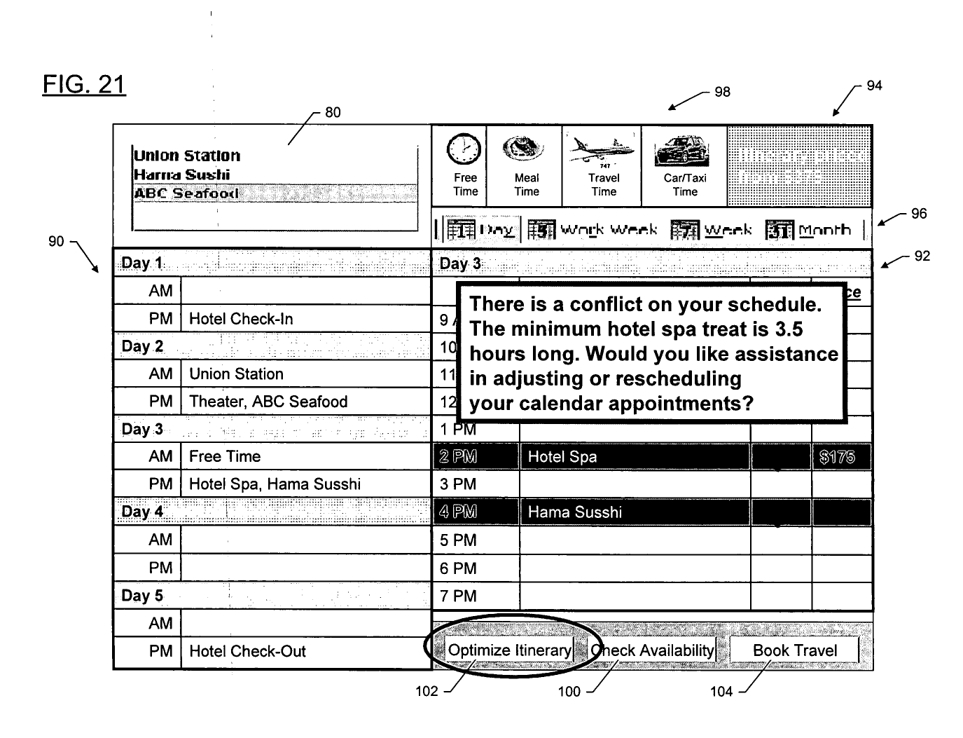

FIG. 21 also illustrates the user itinerary creation screen, according to one embodiment of the invention. In FIG. 21, the user has selected the “Optimize Itinerary” button 102. In one embodiment of the invention, the optimization process comprises reviewing the schedule of the travel components within the user itinerary and determining if any conflicts exist and whether it might be desirable to reschedule any of the travel components into a different day and/or time based on a number of different factors. Typically in the optimization process, the processing element 12 will determine if the user has allowed sufficient time to complete each scheduled travel component before the next travel component is scheduled to begin. The processing element will typically determine if the user has allowed sufficient time to travel between scheduled travel components. The processing element will also typically determine if travel time is minimized by ensuring that travel components in close geographic proximity are scheduled on the same day. If the processing element 12 determines that the schedule is not optimal, the processing element will typically cause a message to be displayed to the user, as illustrated in FIG. 21. The processing element 12 will typically suggest alternative days and/or times for one or more travel components to remedy any identified problems. The processing element may also optimize based on the total price of the user itinerary and/or on prices of individual travel components in the user itinerary. For example, the processing element may determine if the total price of the user itinerary can be reduced by modifying the user itinerary (e.g., by changing the departure and return dates). Or the total price of the user itinerary may be compared to a budget defined by the user, such that the processing element may suggest changes to the user itinerary if the total price exceeds the defined budget.

In an alternative embodiment, the user may select the “Optimize Itinerary” button 102 after placing the desired travel components into the shopping cart 80 but prior to scheduling any of the travel components using the scheduler window 90. In such an embodiment, the processing element 12 may create an optimized user itinerary by scheduling each travel component into a day and time based on the optimization factors and any predefined user preferences. The user would typically be able to modify the suggested optimized schedule by dragging and dropping travel components from one day and/or time to another day and/or time.

Once the user is satisfied with the created user itinerary, the user would typically secure reservations for the bookable travel components by selecting the “Book Travel” button 104. The user would typically have to provide payment, such as by providing a credit card number and expiration date. The server 10 will typically transmit information to a GDS 26 and/or a CRS 28 to cause the GDS or CRS to create a reservation record (often termed a passenger name record (PNR)), with each bookable component being a separate line item in the reservation record, and with non-bookable items included as remarks in the reservation record. The GDS or CRS will typically return a confirmation number that may be displayed to the user.

As discussed above, the user itinerary will typically be stored by the server 10 for use as travel information for a future user request. After the user completes the planned trip, the user may enter feedback, such as descriptions, photographs, and/or ratings, corresponding to one or more travel components of the user's trip. In one embodiment, the user feedback may be stored in the reservation record created by the GDS or CRS.

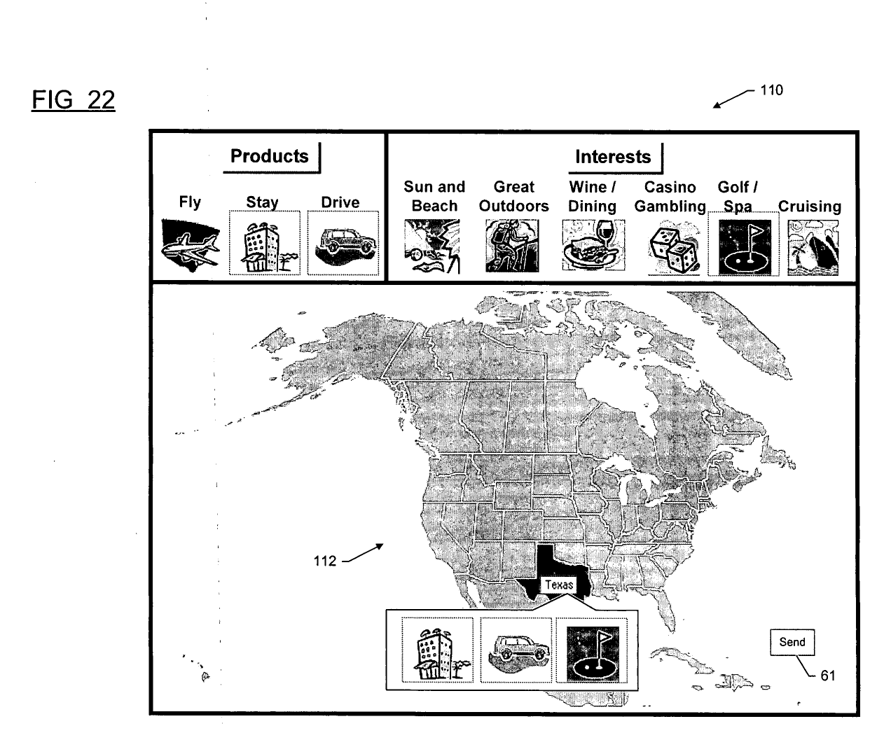

Referring now to FIG. 22, a screen shot of an alternative request entry screen for entering a user request is illustrated, according to one embodiment of the invention. A user may be able to enter a request for travel information by dragging and dropping travel related icons onto a map, such as map 112 of FIG. 22. The icons that are dropped onto the map will typically generate a user request to display travel information corresponding to the icons. The user may drop travel icons at specific locations on the map. For example, a hotel icon may be placed near the location where the traveler wants to stay. The user may be able to drag multiple versions of the same icon and/or several different icons on the map to plan an entire trip. For example, the user may drag an icon multiple times if the user is planning a multi-destination itinerary (e.g., golf and lodging in both Austin & San Antonio). Icons that have been dragged and dropped onto a specific location on the map will typically be displayed at that location. FIG. 22 illustrates three icons (“Stay,” “Drive,” and “Golf/Spa) which have been dropped onto Texas on the map.

Many types of travel icons could be available for the user to drag and drop, including but not limited to: Air, Rail, Cruise, Car, Hotel, Points-Of-Interest (e.g., monuments, museums, and the like), Gas Stations, Shopping Malls, and Restaurants. The user may also be able to drag and drop “Desired Start Point” and “Desired End Point” icons to indicate the user's departure location and destination. Such departure information may be necessary to provide accurate and complete travel mode (e.g., air, train, car, bus, limousine, ferry, cruise ship, etc.) information. The user may also be able to drag and drop icons corresponding with types of travel experiences that may be available, including but not limited to: Sun & Beach, Great Outdoors, Food & Wine, Luxury, Vegas & Casinos, and International travel.

The travel icons may be arranged on an icon palette 110. Various icon palettes may be displayed at different points in time depending on the selections made by the user. There may be, for example, a base or generic palette displayed when the user begins to enter a request, such as palette 110 of FIG. 22 which includes a range of less specific travel options. After dragging and dropping an icon from the base palette onto the map, more specific palettes corresponding to the selected icon may be displayed. For example, selecting the “Cruising” icon may cause a cruise palette to be displayed. A cruise palette may let the user drag and drop icons corresponding to, for example, specialty shore activities onto the map in order to add such activities to the user request. Similarly, selecting the “Fly” icon may cause an air travel palette to be displayed, from which the user may be able to select an icon corresponding to specific a airline or an icon corresponding to the class of ticket desired. A hotel palette may enable the user to select a desired hotel chain or lodging type (e.g., resort, condo, or bed and breakfast). The icon palettes that are displayed may correspond to the destination indicated by the user. For example, the user may be able to select icons corresponding to tickets for movies, sporting events, or amusement parks, based on the destination location and/or dates of travel (if provided).

When the user has finished dragging icons onto the map, the user may select the “Send” button 61. Selecting the Send button will typically submit the user request to provide information corresponding to the selected icons. In one embodiment, the user may be presented with various options to enable a more specific user request. For example, if the user has dragged and dropped a hotel icon onto the map, a list of hotel properties at that location may be displayed such that the user may obtain information regarding a specific property. Similarly, if the user has dragged and dropped an air icon onto the map, current minimum and median ticket prices may be displayed, as well as current flight schedules.

In an alternative embodiment of the invention (not illustrated), the user may drag and drop a selection icon onto any one of several different icons or photographs, with each icon or photograph corresponding to a travel category (e.g., air, train, hotel, etc.) or a travel experience (e.g., Sun & Beach, Great Outdoors, Food & Wine, Luxury, Vegas & Casinos, International travel, etc.). The icons or photographs may be displayed, for example, in a grid. The user would be able to drag and drop a selection icon onto the desired travel category or travel experience. The grid on which the icons or photographs may be displayed, and the map onto which icons may be dropped, may both be termed selection surfaces.

According to one aspect of the invention, all or a portion of the system of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

In this regard, FIG. 2 is a flowchart of methods, systems and program products according to the invention. It will be understood that each block or step of the flowchart, and combinations of blocks in the flowchart, can be implemented by computer program instructions. These computer program instructions may be loaded onto a computer or other programmable apparatus to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that each block or step of the flowchart, and combinations of blocks or steps in the flowchart, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for providing travel information using information obtained from other travelers, the system comprising:
a server capable of accessing travel information in response to a request from a user, the travel information comprising at least a portion of a predefined travel itinerary, the predefined travel itinerary comprising a plurality of bookable and non-bookable travel components; the server further capable of transmitting the travel information to be displayed at a client device; the server further capable of creating a user itinerary comprising at least one travel component in response to a selection by the user of at least a portion of the displayed travel information.

2. The system of claim 1, wherein the predefined travel itinerary corresponds to a previously planned itinerary of a traveler different from the user.

3. The system of claim 1, wherein the travel information further comprises previously experienced travel component information, the previously experienced travel component information corresponding to a previously experienced travel component of a traveler different from the user, the previously experienced travel component designated as a bookable or non-bookable travel component, the previously experienced travel component information comprising a name of the previously experienced travel component and at least one of a location of the previously experienced travel component, a description of the previously experienced travel component, a review of the previously experienced travel component, a suggestion or tip corresponding to the previously experienced travel component, a website link corresponding to the previously experienced travel component, a product or service menu corresponding to the previously experienced travel component, a rating of the previously experienced travel component, and a photograph of the previously experienced travel component.

4. The system of claim 3, further comprising a client device, wherein the client device is capable of displaying the travel information by displaying an icon on a map, wherein a location of the icon on the map corresponds to a geographic location of at least one of a bookable travel component, a non-bookable travel component, and a previously experienced travel component.

5. The system of claim 4, wherein the icon has a visual aspect corresponding to a category of the travel component.

6. The system of claim 3, wherein the request from the user comprises at least one of a key word query, a selection from a drop down list, a selection of a geographic area on a map, and a drag-and-drop selection and placement on a map of an icon corresponding to a travel component category.

7. The system of claim 4, wherein the selection by the user comprises a drag-and-drop selection and placement of at least one of: (a) the predefined travel itinerary, (b) a portion of the predefined travel itinerary, (c) all travel components corresponding to a day of travel in the predefined travel itinerary, (d) a bookable travel component, (e) a non-bookable travel component, (f) an icon, (g) a previously experienced travel component name, (h) a previously experienced travel component photograph, (i) a website link, and 0) a product or service menu.

8. The system of claim 3, wherein the server is further capable of determining a price and availability of each travel component in the user travel itinerary and capable of determining a total price of the user itinerary.

9. The system of claim 3, wherein the server is further capable of rescheduling at least one travel component in the user itinerary, such that the user itinerary is optimized based on at least one of: (a) a number of days of travel, (b) a number of travel components selected, (c) a length of time required for each travel component, (d) a rating of each selected travel component, (e) an availability of each selected travel component, (f) a price of at least one travel component, (g) a total price of the user itinerary, (h) a total price of the user itinerary compared to a user budget, (i) a travel time required between each travel component, () a geographic location of each travel component, (k) a desired amount of free time, and (1) a predefined user preference.

10. The system of claim 9, wherein the server is further capable of moving a selected travel component from one day of travel to a different day of travel or from one period of time to a different period of time in response to a drag-and-drop selection and placement by the user.

11. The system of claim 9, wherein the server is further capable of sending the user itinerary to a global distribution system or a computerized reservation system, such that the global distribution system or the computerized reservation system creates a reservation record, the reservation record comprising a reservation for each bookable travel component and a remark for each non-bookable travel component.

12. The system of claim 11, wherein the server is further capable of storing the user itinerary such that the stored user itinerary is a predefined travel itinerary that the server may use to access travel information in response to a subsequent user request.

13. The system of claim 11, wherein the server is further capable of receiving user feedback corresponding to at least one travel component in the user itinerary, the user feedback comprising at least one of a description of the travel component, a review of the travel component, a suggestion or tip corresponding to the travel component, a rating of the travel component, a website link corresponding to the travel component, a product or service menu corresponding to the travel component, and a photograph of the travel component.

14. The system of claim 13, wherein the server is further capable of storing the received user feedback such that the stored user feedback is previously experienced travel component information that the server may use to access travel information in response to a subsequent user request.

15. A method of providing travel information using information obtained from other travelers, the method comprising:
accessing travel information in response to a request from a user, the travel information comprising at least a portion of a predefined travel itinerary, the predefined travel itinerary comprising a plurality of bookable and non-bookable travel components;
displaying the travel information; and
creating a user itinerary comprising at least one travel component in response to a selection by the user of at least a portion of the displayed travel information.

16. The method of claim 15, wherein the predefined travel itinerary corresponds to a previously planned itinerary of a traveler different from the user.

17. The method of claim 16, wherein the travel information further comprises previously experienced travel component information, the previously experienced travel component information corresponding to a previously experienced travel component of a traveler different from the user, the previously experienced travel component designated as a bookable or non-bookable travel component, the previously experienced travel component information comprising a name of the previously experienced travel component and at least one of a location of the previously experienced travel component, a description of the previously experienced travel component, a review of the previously experienced travel component, a suggestion or tip corresponding to the previously experienced travel component, a website link corresponding to the previously experienced travel component, a product or service menu corresponding to the previously experienced travel component, a rating of the previously experienced travel component, and a photograph of the previously experienced travel component.

18. The method of claim 17, wherein displaying the travel information comprises displaying an icon on a map, wherein a location of the icon on the map corresponds to a geographic location of at least one of a bookable travel component, a non-bookable travel component, and a previously experienced travel component.

19. The method of claim 18, wherein the icon has a visual aspect corresponding to a category of the travel component.

20. The method of claim 17, wherein the request from the user comprises at least one of a key word query, a selection from a drop down list, a selection of a geographic area on a map, and a drag-and-drop selection and placement on a map of an icon corresponding to a travel component category.

21. The method of claim 18, wherein the selection by the user comprises a drag-and-drop selection and placement of at least one of: (a) the predefined travel itinerary, (b) a portion of the predefined travel itinerary, (c) all travel components corresponding to a day of travel in the predefined travel itinerary, (d) a bookable travel component, (e) a non-bookable travel component, (f) an icon, (g) a previously experienced travel component name, (h) a previously experienced travel component photograph, (i) a website link, and 0) a product or service menu.

22. The method of claim 17, further comprising:
determining a price and availability of each travel component in the user itinerary; and
determining a total price of the user itinerary.

23. The method of claim 17, further comprising:
rescheduling at least one travel component in the user itinerary, such that the user itinerary is optimized based on at least one of: (a) a number of days of travel, (b) a number of travel components selected, (c) a length of time required for each travel component, (d) a rating of each selected travel component, (e) an availability of each selected travel component, (f) a price of at least one travel component, (g) a total price of the user itinerary, (h) a total price of the user itinerary compared to a user budget, (i) a travel time required between each travel component, 0) a geographic location of each travel component, (k) a desired amount of free time, and (1) a predefined user preference.

24. The method of claim 23, further comprising:
moving a selected travel component from one day of travel to a different day of travel or from one period of time to a different period of time in response to a drag-and-drop selection and placement by the user.

25. The method of claim 23, further comprising:
sending the user itinerary to a global distribution system or a computerized reservation system such that the global distribution system or the computerized reservation system creates a reservation record, the reservation record comprising a reservation for each bookable travel component and a remark for each non-bookable travel component.

26. The method of claim 25, further comprising:
storing the user itinerary such that the user itinerary is a predefined travel itinerary capable of being used to access travel information in response to a subsequent user request.

27. The method of claim 25, further comprising:
receiving user feedback corresponding to at least one travel component in the user itinerary, the user feedback comprising at least one of a description of the travel component, a review of the travel component, a suggestion or tip corresponding to the travel component, a rating of the travel component, a website link corresponding to the travel component, a rating of the travel component, a website link corresponding to the travel component, a product or service menu corresponding to the travel component, and a photograph of the travel component.

28. The method of claim 27, further comprising:
storing the received user feedback such that the user feedback is previously experienced travel component information capable of being used to access travel information in response to a subsequent user request.

29. A computer program product for providing travel information using information obtained from other travelers, the computer program product comprising at least one computer-readable storage medium having computer-readable program code portions stored therein, the computer-readable program code portions comprising:
a first executable portion capable of accessing travel information in response to a request from a user, the travel information comprising at least a portion of a predefined travel itinerary, the predefined travel itinerary comprising a plurality of bookable and non-bookable travel components;
a second executable portion capable of displaying the travel information; and
a third executable portion capable of creating a user itinerary comprising at least one travel component in response to a selection by the user of at least a portion of the displayed travel information.

30. The computer program product of claim 29, wherein the predefined travel itinerary corresponds to a previously planned itinerary of a traveler different from the user.

31. The computer program product of claim 30, wherein the travel information further comprises previously experienced travel component information, the previously experienced travel component information corresponding to a previously experienced travel component of a traveler different from the user, the previously experienced travel component designated as a bookable or non-bookable travel component, the previously experienced travel component information comprising a name of the previously experienced travel component and at least one of a location of the previously experienced travel component, a description of the previously experienced travel component, a review of the previously experienced travel component, a suggestion or tip corresponding to the previously experienced travel component, a website link corresponding to the previously experienced travel component, a product or service menu corresponding to the previously experienced travel component, a rating of the previously experienced travel component, and a photograph of the previously experienced travel component.

32. The computer program product of claim 31, wherein the first executable portion displays the travel information by displaying an icon on a map, wherein a location of the icon on the map corresponds to a geographic location of at least one of a bookable travel component, a non-bookable travel component, and a previously experienced travel component.

33. The computer program product of claim 32, wherein the icon has a visual aspect corresponding to a category of the travel component.

34. The computer program product of claim 31, wherein the request from the user comprises at least one of a key word query, a selection from a drop down list, a selection of a geographic area on a map, and a drag-and-drop selection and placement on a map of an icon corresponding to a travel component category.

35. The computer program product of claim 32, wherein the selection by the user comprises a drag-and-drop selection and placement of at least one of: (a) the predefined travel itinerary, (b) a portion of the predefined travel itinerary, (c) all travel components corresponding to a day of travel in the predefined travel itinerary, (d) a bookable travel component, (e) a non-bookable travel component, (f) an icon, (g) a previously experienced travel component name, (h) a previously experienced travel component photograph, (i) a website link, and (0) a product or service menu.

36. The computer program product of claim 31, further comprising:
a fourth executable portion capable of determining a price and availability of each travel component in the user itinerary; and
a fifth executable portion capable of determining a total price of the user itinerary.

37. The computer program product of claim 31, further comprising:
a fourth executable portion capable of rescheduling at least one travel component in the user itinerary, such that the user itinerary is optimized based on at least one of: (a) a number of days of travel, (b) a number of travel components selected, (c) a length of time required for each travel component, (d) a rating of each selected travel component, (e) an availability of each selected travel component, (f) a price of at least one travel component, (g) a total price of the user itinerary, (h) a total price of the user itinerary compared to a user budget, (i) a travel time required between each travel component, (0) a geographic location of each travel component, (k) a desired amount of free time, and (1) a predefined user preference.

38. The computer program product of claim 37, further comprising:
a fifth executable portion capable of moving a selected travel component from one day of travel to a different day of travel or from one period of time to a different period of time in response to a drag-and-drop selection and placement by the user.

39. The computer program product of claim 37, further comprising:
a fifth executable portion capable of sending the user itinerary to a global distribution system or a computerized reservation system such that the global distribution system or the computerized reservation system creates a reservation record, the reservation record comprising a reservation for each bookable travel component and a remark for each non-bookable travel component.

40. The computer program product of claim 39, further comprising:
a sixth executable portion capable of storing the user itinerary such that the user itinerary is a predefined travel itinerary capable of being used to access travel information in response to a subsequent user request.

41. The computer program product of claim 39, further comprising:
a sixth executable portion capable of receiving user feedback corresponding to at least one travel component in the user itinerary, the user feedback comprising at least one of a description of the travel component, a review of the travel component, a suggestion or tip corresponding to the travel component, a rating of the travel component, a website link corresponding to the travel component, a product or service menu corresponding to the travel component, and a photograph of the travel component.

42. The computer program product of claim 41, further comprising:
a seventh executable portion capable of storing the received user feedback such that the user feedback is previously experienced travel component information capable of being used to access travel information in response to a subsequent user request.

43. A system for providing travel information, the system comprising:
a server capable of accessing travel information in response to a request from a user, the request from the user comprising a drag-and-drop selection and placement of an icon onto a selection surface.

44. The system of claim 43, wherein the travel information is selected from the group comprising a price of a travel component, an availability of a travel component, a review of a travel component, a rating of a travel component, a photograph of a travel component, a travel journal entry corresponding to a travel component, and a travel itinerary containing a travel component.

45. The system of claim 43, wherein the icon corresponds to a category of travel information, and wherein the server accesses travel information corresponding to the category of travel information.

46. The system of claim 45, wherein the icon is selected from a plurality of icons, each of the plurality of icons corresponding to a different category of travel information.

47. The system of claim 45, wherein the selection surface is a map, and wherein the server accesses travel information corresponding to the category of travel information and to a location of the icon on the map.

48. The system of claim 45, wherein the category of travel information is selected from the group comprising airplane travel, train travel, cruise ship travel, ferry travel, lodging accommodations, rental cars, buses, limousines, taxis, restaurants, tours, event tickets, entertainment activities, and sightseeing activities

49. The system of claim 43, wherein the selection surface is a map, wherein the icon is a first icon that is dragged and dropped onto a first location on the map, the first location corresponding to a travel departure point, wherein the request from the user further comprises a drag-and-drop selection and placement of a second icon onto a second location on the map, the second location corresponding to a travel destination point, and wherein the server accesses travel information corresponding to a mode of transportation from the travel departure point to the travel destination point.

50. The system of claim 49, wherein the mode of transportation is selected from the group comprising air travel, train travel, bus travel, cruise ship travel, ferry travel, boat travel, limousine travel, taxi travel, and rental car travel.

51. The system of claim 43, wherein the selection surface is a grid comprising a plurality of grid sections, each of the plurality of grid sections corresponding to a different category of travel information or a different travel experience, wherein the icon is dragged and dropped onto a grid section corresponding to a desired category of travel information or a desired travel experience, and wherein the server accesses travel information corresponding to the desired category of travel information or the desired travel experience.

52. A method for providing travel information, the method comprising:
accessing travel information in response to a request from a user, the request from the user comprising a drag-and-drop selection and placement of an icon onto a selection surface.

53. The method of claim 52, wherein the travel information is selected from the group comprising a price of a travel component, an availability of a travel component, a review of a travel component, a rating of a travel component, a photograph of a travel component, a travel journal entry corresponding to a travel component, and a travel itinerary containing a travel component.

54. The method of claim 52, wherein the icon corresponds to a category of travel information, and wherein accessing travel information comprises accessing travel information corresponding to the category of travel information.

55. The method of claim 54, wherein the icon is selected from a plurality of icons, each of the plurality of icons corresponding to a different category of travel information.

56. The method of claim 54, wherein the selection surface is a map, and wherein accessing travel information comprises accessing travel information corresponding to the category of travel information and to a location of the icon on the map.

57. The method of claim 54, wherein the category of travel information is selected from the group comprising airplane travel, train travel, cruise ship travel, ferry travel, lodging accommodations, rental cars, buses, limousines, taxis, restaurants, tours, event tickets, entertainment activities, and sightseeing activities

58. The method of claim 52, wherein the selection surface is a map, wherein the icon is a first icon that is dragged and dropped onto a first location on the map, the first location corresponding to a travel departure point, wherein the request from the user further comprises a drag-and-drop selection and placement of a second icon onto a second location on the map, the second location corresponding to a travel destination point, and wherein accessing travel information comprises accessing travel information corresponding to a mode of transportation from the travel departure point to the travel destination point.

59. The method of claim 58, wherein the mode of transportation is selected from the group comprising air travel, train travel, bus travel, cruise ship travel, ferry travel, boat travel, limousine travel, taxi travel, and rental car travel.

60. The method of claim 52, wherein the selection surface is a grid comprising a plurality of grid sections, each of the plurality of grid sections corresponding to a different category of travel information or a different travel experience, wherein the icon is dragged and dropped onto a grid section corresponding to a desired category of travel information or a desired travel experience, and wherein accessing travel information comprises accessing travel information corresponding to the desired category of travel information or the desired travel experience.
